(19) United States
(12) Patent Application Publication
(10) Pub. No.: US 2010/0182543 A1
(43) Pub. Date: Jul. 22, 2010

(54) LIQUID CRYSTALLINE COMPOSITION AND LIGHT ABSORPTION ANISOTROPIC FILM, A POLARIZING ELEMENT AND A LIQUID CRYSTAL DISPLAY DEVICE, EACH EMPLOYING THE SAME

(75) Inventors: Ryoji GOTO, Minami-ashigara-shi (JP); Shinichi Morishima, Minami-ashigara-shi (JP); Eri Utagawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/688,263

(22) Filed: Jan. 15, 2010

(30) Foreign Application Priority Data
Jan. 16, 2009 (JP) 2009-007463

(51) Int. Cl. G02F 1/1347; C09K 19/22; B05D 5/12; G02F 1/13

(52) U.S. Cl. 349/74; 252/299.68; 427/67; 349/194

(57) ABSTRACT

A liquid crystalline composition, having a liquid crystalline dichroic azo dye that is represented by formula (I) and has an expression temperature of the nematic phase of 150° C. to 300° C. in a temperature elevating process, and at least one liquid crystalline dichroic azo dye, wherein an expression temperature of the nematic phase of the liquid crystalline composition is 120° C. or higher in a temperature elevating process:

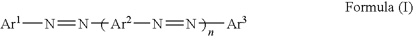

wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

### FIELD OF THE INVENTION

The present invention relates to a liquid crystalline composition containing dichroic azo dyes. Further, the present invention relates to a light absorption anisotropic film, a polarizing element and a liquid crystal display device, each employing the liquid crystalline composition.

### BACKGROUND OF THE INVENTION

When functions such as an attenuation function, a polarization function, a scattering function and a light-shielding function is required to effect for an irradiated light including a laser light and a natural light employed, an apparatus which operates based on a different principle was adapted conventionally depending on the function required. Accordingly, products corresponding to the functions were prepared respectively by production processes that were different depending on the respective functions.

For example, in LCD (Liquid Crystal Display), linear polarizing plates or circular polarizing plates are used to control optical rotation or birefringence in display. Also in OLED (Organic Electroluminescence), circular polarizing plates are used to prevent reflection of external outside light. Heretofore, for such polarizing plates (polarizing elements), iodine has been widely used as a dichroic material. However, if iodine is used for a polarizing plate, its heat resistance or light fastness is insufficient since iodine is highly sublimable. Further, the extinction color becomes dark grayish blue, and an ideal achromatic color polarizing plate for the entire visible spectral region cannot necessarily be obtained.

Therefore, a polarizing element has been studied wherein an organic dye is used as a dichroic material which replaces iodine. However, such an organic dye has a problem such that only polarizing elements are obtainable which are distinctly inferior to those employing iodine for dichroic property. Particularly, a polarizing element is an important constituent in LCD employing as the display principle optical rotation or birefringence of light, and a new polarizing element has been developed for the purpose of improving display performance and the like in recent years.

As one method of forming such a polarizing element, a method may be mentioned wherein, in the same manner as in the case of a polarizing film containing iodine, an organic dye having dichroism (dichroic dye) is dissolved or adsorbed in a polymer material such as a polyvinyl alcohol, and the obtained film is stretched in one direction into a film so that the dichroic dye is oriented. However, this method had such a problem that time and effort are required for e.g. the stretching step.

Thus, other methods attract attention in recent years and as such methods, Dreyer, J. F., Journal de Physique, 1969, 4, 114, “Light Polarization From Films of Lyotropic Nematic Liquid Crystals” discloses a method of orientating a dichroic dye on a substrate such as glass or a transparent film utilizing e.g. intermolecular interaction of organic dye molecules, to form a polarizing film (anisotropic dye film). However, it was known that there was a problem for heat resistant property in the method described in the above document.

Further, the method of orienting a dichroic dye on a substrate such as glass or a transparent film utilizing e.g. intermolecular interaction of organic dye molecules may be a wet system film-forming method. In a case where an anisotropic dye film is prepared by the wet system film-forming method, the dye molecules to be used for the dye film are required not only to show high degree of dichroism but also to be a dye suitable for the process for the wet system film-forming method. Examples of the process in the wet system film-forming method include a process of disposing and orientating the dye on a substrate or a process of controlling the orientation. Therefore, there are many cases that even the conventional dyes that can be employed for the polarizing elements passing through the above-mentioned stretching treatment are not suitable for the wet system film-forming method. Further, JP-A-2002-180052 (“JP-A” means unexamined published Japanese patent application), JP-A-2002-528758 and JP-A-2002-338838 propose materials suitable for the process of the wet system film-forming method. However, although such materials are suitable for the process, they have had such a drawback that they cannot show high dichroism.

Further, JP-T-8-511109 (“JP-T” means published searched patent publication) proposes a dye represented by chromogen (SO₃M)ₙ as a material suitable for the process. In the document, the achromatic color is given by combining several kinds of dichroic dyes with each other. However, when an anisotropic dye film is obtained by combining the several kinds of dichroic dyes with each other, a molecular orientation for mixing different molecules is disturbed and there was a problem that achieving a high dichroism is difficult.

Meanwhile, when a light absorption anisotropic film is exposed under a high temperature condition, disturbance of orientation distribution arising from a molecular movement occurs whereby dichroism conspicuously reduces in some cases. Further, under a high temperature condition crystallization occurs and multi-domain is formed in some cases. As the technique for preventing anisotropic thin film consisting an organic molecule as a component from reduction in degree of orientation under a high temperature condition, for example, with respect to non-linear optical materials, several methods are known, for example, a method of using a main chain type liquid crystalline polymer having a high crystal-nematic phase transition temperature (JP-A-5-150255), a method of using a main chain type polymer having a high glass transition temperature (JP-A-6-186601), a method of using a side chain type polymer in which a hydrogen-bonding portion is introduced (JP-A-8-220575), a method of combining a non-linear optically active low molecule and a polymer binder having a high glass transition temperature (JP-A-2005-227368), and the like. Further, with respect to the light absorption anisotropic film (polarizing film), JP-A-2006-79030 describes that a water-soluble azo dye thin film having a specific periodic structure has high heat resistance compared to that of a previous iodine-type polarizing film. However, there is nothing of specific descriptions of the temperature and the degree of reduction in degree of orientation.

### SUMMARY OF THE INVENTION

The present invention resides in a liquid crystalline composition comprising a liquid crystalline dichroic azo dye that is represented by formula (I) and has an expression temperature of the nematic phase of 150° C. to 300° C. in a temperature elevating process, and at least one liquid crystalline dichroic azo dye, wherein a nematic phase expression temperature of the liquid crystalline composition in a temperature elevating process is 120° C. or higher:

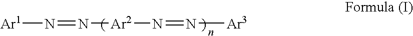

wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

Further, the present invention resides in a light absorption anisotropic film formed by employing the above-described liquid crystalline composition.

Further, the present invention resides in a polarizing element comprising an alignment film and the above-described light absorption anisotropic film on a support.

Further, the present invention resides in a liquid crystal display device comprising the above-described light absorption anisotropic film or the above-described polarizing element.

Furthermore, the present invention resides in a method of producing the above-described polarizing element, comprising the steps of:

(1) rubbing a support or an alignment film formed on a support;

(2) applying the above-described composition dissolved in an organic solvent on the rubbing treated support or alignment film; and

(3) orientating the liquid crystalline composition by causing the organic solvent to evaporate.

Other and further features and advantages of the invention will appear more fully from the following description.

### DETAILED DESCRIPTION OF THE INVENTION

As a result of intensive studies on the above-described problems, the present inventors have found that a liquid crystalline composition capable of forming a light absorption anisotropic film maintaining a high dichroic ratio even at a high temperature can be obtained by the following means.

According to the present invention, there is provided the following means:

<1> A liquid crystalline composition, comprising a liquid crystalline dichroic azo dye that is represented by formula (I) and has an expression temperature of the nematic phase in a temperature elevating process (hereinafter, referred to as “nematic phase transition temperature” in some cases) of 150° C. to 300° C., and at least one liquid crystalline dichroic azo dye, wherein an expression temperature of the nematic phase of the liquid crystalline composition in a temperature elevating process is 120° C. or higher:

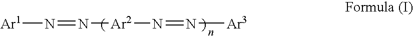

wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

<2> The liquid crystalline composition described in the above item <1>, wherein the dichroic azo dye represented by formula (I) is a compound represented by formula (II):

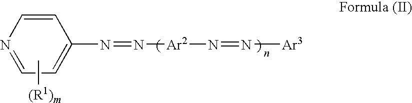

wherein R¹ represents a substituent; Ar² is a divalent substituted or unsubstituted aromatic hydrocarbon group or a divalent substituted or unsubstituted aromatic heterocyclic group; Ar³ represents a substituted or unsubstituted, aromatic hydrocarbon ring group or aromatic heterocyclic group; n represents an integer of 1 or more; when n is an integer of 2 or more, Ar²s may be the same as or different from each other; m represents an integer of 0 to 4; and when m is an integer of 2 or more, R¹s may be the same as or different from each other.

<3> The liquid crystalline composition described in the above item <1> or <2>, wherein the dichroic azo dye represented by formula (I) or (II) is a compound represented by formula (III):

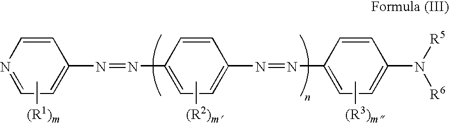

wherein R¹, R², R³, R⁵ and R⁶ each independently represent a substituent; n represents an integer of 1 or more; when n is an integer of 2 or more, R²s may be the same as or different from each other; m represents an integer of 0 to 4; when m is an integer of 2 or more, R¹s may be the same as or different from each other; m′ represents an integer of 0 to 4; when m′ is an integer of 2 or more, R²s may be the same as or different from each other; m″ represents an integer of 0 to 4; when m″ is an integer of 2 or more, R³s may be the same as or different from each other; when two or more than two R² or R³ are present, a plurality of R² or R³ may bond to each other to form a ring respectively; and R³, R⁵, and R⁶ may bond to each other to form a ring.

<4> The liquid crystalline composition as described in any one of the above items <1> to <3>, comprising a liquid crystalline dichroic azo dye that is represented by the above-described formula (I) and has an expression temperature of the nematic phase of 150° C. to 300° C. in a temperature elevating process, and at least one liquid crystalline dichroic azo dye represented by formula (IV):

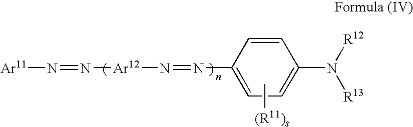

wherein R¹¹, R¹² and R¹³ each independently represent a hydrogen atom or a substituent; Ar¹¹ is a substituted or unsubstituted phenyl group, a substituted or unsubstituted naphthyl group, or a substituted or unsubstituted aromatic heterocyclic group excluding a pyridyl group; Ar¹² is a divalent substituted or unsubstituted aromatic hydrocarbon group or a divalent substituted or unsubstituted aromatic heterocyclic group; s represents an integer of 0 to 4; when s is an integer of 2 or more, R¹¹s may be the same as or different from each other; p represents an integer of 1 to 5; and when p is an integer of 2 or more, Ar¹²s may be the same as or different from each other.

<5> The liquid crystalline composition described in the above item <4>, wherein, in formula (IV), Ar¹¹ represents a substituted or unsubstituted phenyl group; Ar¹² represents a divalent substituted or unsubstituted phenylene group; and p represents an integer of 2 to 4.
<6> The liquid crystalline composition described in the above item <4> or <5>, wherein the azo dye represented by formula (IV) is a compound represented by formula (V):

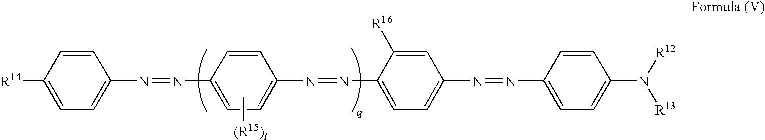

wherein R¹², R¹³ and R¹⁵ each independently represent a hydrogen atom or a substituent; R¹⁴ represents a substituted or unsubstituted, alkyl group, alkenyl group, alkynyl group, aryl group, alkoxy group, alkoxycarbonyl group, acyloxy group, acylamino group, alkoxycarbonylamino group, sulfonylamino group, sulfamoyl group, carbamoyl group, alkylthio group, sulfonyl group or ureido group; R¹⁶ represents an alkyl group; t represents an integer of 0 to 4; when t is an integer of 2 or more, R¹⁵s may be the same as or different from each other; and q represents an integer of 1 to 3.

<7> A light absorption anisotropic film formed by employing the liquid crystalline composition described in any one of the above items <1> to <6>.
<8> A polarizing element comprising an alignment film and the light absorption anisotropic film described in the above item <7> on a support.
<9> A liquid crystal display device comprising the light absorption anisotropic film described in the above item <7> or the polarizing element described in the above item <8>.
<10> A method of producing the polarizing element described in the above item <8>, comprising the steps of:

(1) rubbing a support or an alignment film formed on a support;

(2) applying the liquid crystalline composition described in any one of the above items <1> to <6> dissolved in an organic solvent on the rubbing treated support or alignment film; and

(3) orientating the liquid crystalline composition by causing the organic solvent to evaporate.

<11> A method of producing the liquid crystalline composition as described in the above item <1>, the method comprising a step of mixing a liquid crystalline dichroic azo dye that is represented by formula (I) and has an expression temperature of the nematic phase of 150° C. to 300° C. in a temperature elevating process, and at least one liquid crystalline dichroic azo dye, thereby obtaining a liquid crystalline composition having an expression temperature of the nematic phase of 120° C. or more in a temperature elevating process.

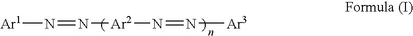

wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

In the present invention, the term “dichroic dye” is defined as meaning a dye whose absorbing wavelength is different depending on the direction. Further, “dichroism” is calculated as a ratio of an absorbance of polarization in an absorption axis direction with respect to an absorbance of polarization in a polarization axis direction when the dichroic dye composition is used for the light absorption (optically) anisotropic film.

Further, the term “heat resistance” used in the present invention means resistance properties to decomposition of the molecule itself or disturbance of orientation distribution owing to heat. However, a purpose of the heat resistance in the present invention is to prevent the reduction in dichroism (polarization degree) mainly arising from the disturbance of orientation distribution.

The liquid crystalline composition of the present invention contains at least two dichroic azo dyes, and further has a nematic phase transition temperature of 120° C. or more whereby system-wide crystallinity is lowered and crystallization arising from thermal stimulation is prevented, and in addition thereto the reduction in orientation (alignment) degree at a high temperature can be suppressed. The nematic phase transition temperature of the liquid crystalline composition is preferably from 140° C. to 300° C., more preferably from 160° C. to 300° C., and further preferably from 200° C. to 300° C.

In this case, at least one of among these dichroic azo dyes is a compound that is represented by the above-described foiinula (I) and has a nematic phase transition temperature of 150° C. to 300° C. The nematic phase transition temperature of this dichroic azo dye is preferably from 180° C. to 300° C., more preferably from 200° C. to 300° C., and further preferably from 230° C. to 300° C.

In the liquid crystalline composition of the present invention, among the azo dyes represented by formula (I), a compound having a nematic phase transition temperature that meets the above-described requirement is used.

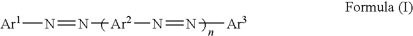

In formula (I), Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

Examples of the substituent which may be substituted on Ar¹, Ar² and Ar³ in formula (I) include an alkyl group (preferably an alkyl group having from 1 to 20, more preferably from 1 to 12, and particularly preferably from 1 to 8 carbon atoms, e.g., a methyl group, an ethyl group, an iso-propyl group, a tert-butyl group, an n-octyl group, an n-decyl group, an n-hexadecyl group, a cyclopropyl group, a cyclopentyl group, a cyclohexyl group), an alkenyl group (preferably an alkenyl group having from 2 to 20, more preferably from 2 to 12, and particularly preferably from 2 to 8 carbon atoms, e.g., a vinyl group, an allyl group, a 2-butenyl group, a 3-pentenyl group), an alkynyl group (preferably an alkynyl group having from 2 to 20, more preferably from 2 to 12, and particularly preferably from 2 to 8 carbon atoms, e.g., a propargyl group, a 3-pentynyl group), an aryl group (preferably an aryl group having from 6 to 30, more preferably from 6 to 20, and particularly preferably from 6 to 12 carbon atoms, e.g., a phenyl group, 2,6-diethylphenyl group, 3,5-di(trifluoromethyl)phenyl group, a naphthyl group, a biphenyl group), a substituted or unsubstituted amino group (preferably an amino group having from 0 to 20, more preferably from 0 to 10, and particularly preferably from 0 to 6 carbon atoms, e.g., an unsubstituted amino, a methylamino group, a dimethylamino group, a diethylamino group, an anilino group), an alkoxy group (preferably an alkoxy group having from 1 to 20, more preferably from 1 to 10, and particularly preferably from 1 to 6 carbon atoms, e.g., a methoxy group, an ethoxy group, a butoxy group), an alkoxycarbonyl group (preferably an alkoxycarbonyl group having from 2 to 20, more preferably from 2 to 10, and particularly preferably from 2 to 6 carbon atoms, e.g., a methoxycarbonyl group, an ethoxycarbonyl group), an acyloxy group (preferably an acyloxy group having from 2 to 20, more preferably from 2 to 10, and particularly preferably from 2 to 6 carbon atoms, e.g., an acetoxy group, a benzoyloxy group), an acylamino group (preferably an acylamino group having from 2 to 20, more preferably from 2 to 10, and particularly preferably from 2 to 6 carbon atoms, e.g., an acetylamino group, a benzoylamino group), an alkoxycarbonylamino group (preferably an alkoxycarbonylamino group having from 2 to 20, more preferably from 2 to 10, and particularly preferably from 2 to 6 carbon atoms, e.g., a methoxycarbonylamino group), an aryloxycarbonylamino group (preferably an aryloxycarbonylamino group having from 7 to 20, more preferably from 7 to 16, and particularly preferably from 7 to 12 carbon atoms, e.g., a phenyloxycarbonylamino group), a sulfonylamino group (preferably a sulfonylamino group having from 1 to 20, more preferably from 1 to 10, and particularly preferably from 1 to 6 carbon atoms, e.g., a methanesulfonylamino group, a benzenesulfonylamino group), a sulfamoyl group (preferably a sulfamoyl group having from 0 to 20, more preferably from 0 to 10, and particularly preferably from 0 to 6 carbon atoms, e.g., a sulfamoyl group, a methylsulfamoyl group, a dimethylsulfamoyl group, a phenylsulfamoyl group), a carbamoyl group (preferably a carbamoyl group having from 1 to 20, more preferably from 1 to 10, and particularly preferably from 1 to 6 carbon atoms, e.g., an unsubstituted carbamoyl group, a methylcarbamoyl group, a methylcarbamoyl group, a phenylcarbamoyl group), an alkylthio group (preferably an alkylthio group having from 1 to 20, more preferably from 1 to 10, and particularly preferably from 1 to 6 carbon atoms, e.g., a methylthio group, an ethylthio group), an arylthio group (preferably an arylthio group having from 6 to 20, more preferably from 6 to 16, and particularly preferably from 6 to 12 carbon atoms, e.g., a phenylthio group), a sulfonyl group (preferably a sulfonyl group having from 1 to 20, more preferably from 1 to 10, and particularly preferably from 1 to 6 carbon atoms, e.g., a mesyl group, a tosyl group), a sulfinyl group (preferably a sulfinyl group having from 1 to 20, more preferably from 1 to 10, and particularly preferably from 1 to 6 carbon atoms, e.g., a methanesulfinyl group, a benzenesulfinyl group), a ureido group (preferably a ureido group having from 1 to 20, more preferably from 1 to 10, and particularly preferably from 1 to 6 carbon atoms, e.g., an unsubstituted ureido group, a methylureido group, a phenylureido group), a phosphoric acid amido group (preferably a phosphoric acid amido group having from 1 to 20, more preferably from 1 to 10, and particularly preferably from 1 to 6 carbon atoms, e.g., a diethylphosphoric acid amido group, a phenylphosphoric acid amido group), a hydroxy group, a mercapto group, a halogen atom (e.g., a fluorine atom, a chlorine atom, a bromine atom, or an iodine atom), a cyano group, a nitro group, a hydroxamic acid group, a sulfino group, a hydrazino group, an imino group, a heterocyclic group (preferably a heterocyclic group having from 1 to 30, and more preferably from 1 to 12 carbon atoms; containing, as a hetero atom(s), for example, a nitrogen atom, an oxygen atom, or a sulfur atom, and specifically, e.g., an imidazolyl group, a pyridyl group, a quinolyl group, a furyl group, a piperidyl group, a morpholino group, a benzoxazolyl group, a benzimidazolyl group, a benzthiazolyl group can be exemplified), and a silyl group (preferably a silyl group having 3 to 40, more preferably 3 to 30, and particularly preferably 3 to 24 carbon atoms, e.g. a trimethylsilyl group, a triphenylsilyl group).

These substituents may further be substituted. When two or more substituents are present, the substituents may be the same as or different from each other. Alternatively, they may bind to each other, forming a ring, if possible.

Ar² represents a divalent substituted or unsubstituted aromatic hydrocarbon group or a divalent substituted or unsubstituted aromatic heterocyclic group. The aromatic hydrocarbon group represented by Ar² is preferably a phenylene group or a naphthylene group. With regard to the substituent which may be possessed by the phenylene group or the naphthylene group, a group which is introduced in order to raise a solubility of the azo compound, a group having an electron donative property or an electron withdrawing property which is introduced in order to adjust color tone as a dye, or a group having the polymerizable group which is introduced in order to fixate an orientation is preferable. Specifically, examples of the substituent are the same as those described above. Preferred examples of the substituent include a substituted or unsubstituted alkyl group, a substituted or unsubstituted alkenyl group, a substituted or unsubstituted alkynyl group, a substituted or unsubstituted aryl group, a substituted or unsubstituted alkoxy group, a substituted or unsubstituted alkoxycarbonyl group, a substituted or unsubstituted acyloxy group, a substituted or unsubstituted acylamino group, a substituted or unsubstituted amino group, a substituted or unsubstituted alkoxycarbonylamino group, a substituted or unsubstituted sulfonylamino group, a substituted or unsubstituted sulfamoyl group, a substituted or unsubstituted carbamoyl group, a substituted or unsubstituted alkylthio group, a substituted or unsubstituted sulfonyl group, a substituted or unsubstituted ureido group, a nitro group, a hydroxy group, a cyano group and a halogen atom.

The alkyl group is an alkyl group having preferably from 1 to 20 carbon atoms, more preferably from 1 to 12 carbon atoms. Examples of the group which may be substituted on the alkyl group include an alkoxy group, an acyloxy group, a hydroxy group and a halogen atom.

The group which may be substituted on the alkyl group is preferably a polymerizable group. The polymerization reaction of the polymerizable group, but not to be limited to, is preferably addition polymerization (including ring opening polymerization) or condensation polymerization. In other words, the polymerizable group is preferably a polymerizable group capable of addition polymerization reaction or condensation polymerization reaction.

Specific examples of the polymerizable group are shown below, but the invention is not meant to be limited to these. In formulae, ‘Et’ represents an ethyl, and ‘Pr’ represents a propyl.

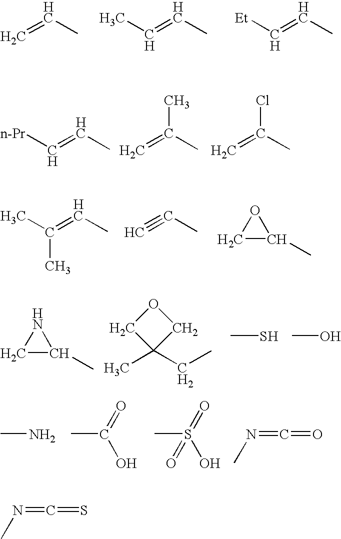

The polymerizable group is preferably a polymerizable group capable of a radical polymerization or a cationic polymerization. General radically polymerizable group can be used as the radically polymerizable group and a (meta)acrylate group is preferable. General cationically polymerizable group can be used as the cationically polymerizable group. Specific examples include an alicyclic ether group, a cyclic acetal group, a cyclic lactone group, a cyclic thioether group, a spiro orthoester group, and a vinyloxy group. Among those, an alicyclic ether group and a vinyloxy group are preferred; and an epoxy group, an oxetanyl group, and a vinyloxy group are particularly preferable.

The alkenyl group is an alkenyl group having preferably from 2 to 20 carbon atoms, more preferably from 2 to 12 carbon atoms. The group which may be substituted on the alkenyl group is synonymous with the group which may be substituted on the alkyl group and the preferable examples are also the same.

The alkynyl group is an alkynyl group having preferably from 2 to 20 carbon atoms, more preferably from 2 to 12 carbon atoms. The group which may be substituted on the alkynyl group is synonymous with the group which may be substituted on the alkyl group and the preferable examples are also the same.

The aryl group is an aryl group having preferably from 6 to 20 carbon atoms, more preferably from 6 to 12 carbon atoms. The group which may be substituted on the aryl group is synonymous with the group which may be substituted on the alkyl group and the preferable examples are also the same.

The alkoxy group is an alkoxy group having preferably from 1 to 20 carbon atoms, more preferably from 1 to 12 carbon atoms. The group which may be substituted on the alkoxy group is synonymous with the group which may be substituted on the alkyl group and the preferable examples are also the same.

The alkoxycarbonyl group is an alkoxycarbonyl group having preferably from 2 to 20 carbon atoms, more preferably from 2 to 12 carbon atoms. The group which may be substituted on the alkoxycarbonyl group is synonymous with the group which may be substituted on the alkyl group and the preferable examples are also the same.

The acyloxy group is an acyloxy group having preferably from 2 to 20 carbon atoms, more preferably from 2 to 12 carbon atoms. The group which may be substituted on the acyloxy group is synonymous with the group which may be substituted on the alkyl group and the preferable examples are also the same.

The amino group is an amino group having preferably from 1 to 20 carbon atoms, more preferably from 1 to 12 carbon atoms. The group which may be substituted on the amino group is synonymous with the group which may be substituted on the alkyl group and the preferable examples are also the same.

The acylamino group is an acylamino group having preferably from 1 to 20 carbon atoms, more preferably from 1 to 12 carbon atoms. The group which may be substituted on the acylamino group is synonymous with the group which may be substituted on the alkyl group and the preferable examples are also the same.

The alkoxycarbonylamino group is an acylamino group having preferably from 2 to 20 carbon atoms, more preferably from 2 to 12 carbon atoms. The group which may be substituted on the alkoxycarbonylamino group is synonymous with the group which may be substituted on the alkyl group and the preferable examples are also the same.

The sulfonylamino group is a sulfonylamino group having preferably from 1 to 20 carbon atoms, more preferably from 1 to 12 carbon atoms. The group which may be substituted on the sulfonylamino group is synonymous with the group which may be substituted on the alkyl group and the preferable examples are also the same.

The sulfamoyl group is a sulfamoyl group having preferably from 1 to 20 carbon atoms, more preferably from 1 to 12 carbon atoms. The group which may be substituted on the sulfamoyl group is synonymous with the group which may be substituted on the alkyl group and the preferable examples are also the same.

The group which may be substituted on the carbamoyl group is synonymous with the group which may be substituted on the alkyl group and the preferable examples are also the same.

The alkylthio group is an alkylthio group having preferably from 1 to 20 carbon atoms, more preferably from 1 to 12 carbon atoms. The group which may be substituted on the alkylthio group is synonymous with the group which may be substituted on the alkyl group and the preferable examples are also the same.

The sulfonyl group is a sulfonyl group having preferably from 1 to 20 carbon atoms, more preferably from 1 to 12 carbon atoms. The group which may be substituted on the sulfonyl group is synonymous with the group which may be substituted on the alkyl group and the preferable examples are also the same.

The ureido group is an ureido group having preferably from 2 to 20 carbon atoms, more preferably from 2 to 12 carbon atoms. The group which may be substituted on the ureido group is synonymous with the group which may be substituted on the alkyl group and the preferable examples are also the same.

The phenylene group or the naphthylene group may have these substituents in numbers of 1 to 5, preferably 1 or 2.

The aromatic heterocyclic group represented by Ar² is preferably a group having a heterocyclic origin of single ring or double rings. Examples of the atom composing the aromatic heterocyclic group excluding the carbon atom include a nitrogen atom, a sulfur atom and an oxygen atom, and the nitrogen atom is particularly preferable. When the aromatic heterocyclic group has a plurality of atom excluding the carbon atom, those atoms may be the same with, or different from each other. Specific examples of the aromatic heterocyclic group include a pyridinediyl group, a quinolinediyl group, an isoquinolinediyl group, a benzothiadiazolediyl group, and a phthalimidediyl group. Among those, a quinolinediyl group and a isoquinolinediyl group are preferable.

Examples of the substituent which may be possessed by the aromatic heterocyclic group include an alkyl group such as a methyl group and an ethyl group, an alkoxy group such as a methoxy group and an ethoxy group, an amino group such as an unsubstituted amino group and a methylamino group, an acetylamino group, an acylamino group, a nitro group, a hydroxy group, a cyano group and a halogen atom.

Ar² is particularly preferably a divalent substituted or unsubstituted phenylene group. The substituent which may be possessed by Ar² is particularly preferably a methyl group.

n represents an integer of 1 or more; preferably an integer of 1 or 2.

Ar¹ and Ar³ each independently represent a substituted or unsubstituted, aromatic hydrocarbon ring group or aromatic heterocyclic group.

The aromatic hydrocarbon ring group represented by Ar¹ and Ar³ is preferably a phenyl group or a naphthyl group. Examples of the substituent which the aromatic hydrocarbon may have include a substituted or unsubstituted alkyl group, a substituted or unsubstituted alkoxy group, a hydroxy group, a nitro group, a halogen atom, a substituted or unsubstituted amino group, a substituted or unsubstituted acylamino group, and a cyano group. Additionally, a preferable number of carbon atoms and the substituent which may be possessed in the substituted alkyl group, the substituted alkoxy group, the substituted amino group and the substituted acylamino group are synonymous with that described in the case of the above-mentioned Ar² being the phenylene group or the naphthylene group, and the preferable examples are also the same.

The aromatic heterocyclic group is preferably a group having a heterocyclic origin of single ring or double rings. Examples of the atom excluding a carbon atom which composes the aromatic heterocyclic group include a nitrogen atom, a sulfur atom and an oxygen atom. When the aromatic heterocyclic group has a plurality of atom excluding the carbon atom, those atoms may be the same with, or different from each other. Specific examples of the aromatic heterocyclic group include a pyridyl group, a thiophenyl group, and a pyridonyl group.

Ar¹ and Ar³ each are particularly preferably substituted or unsubstituted phenyl group.

The dichroic dye used in the present invention is able to increase dichroic ratio (D), for example, to a degree of 10 or more, and the (D) is preferably increased to a degree of 20 to 100. Herein, the dichroic ratio (D) is a value calculated by a method described in the below-described Example.

Among dichroic dyes represented by formula (I) having liquid crystalline properties, dichroic dyes represented by formula (II) are especially preferable.

The dichroic dye represented by formula (II) is described below.

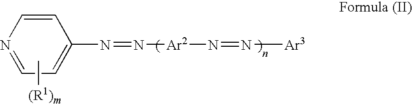

In formula (II), R¹ represents a substituent; Ar² is a divalent substituted or unsubstituted aromatic hydrocarbon group or a divalent substituted or unsubstituted aromatic heterocyclic group; Ar³ represents a substituted or unsubstituted, aromatic hydrocarbon ring group or aromatic heterocyclic group; n represents an integer of 1 or more; when n is an integer of 2 or more, Ar²s may be the same as or different from each other; m represents an integer of 0 to 4; and when m is an integer of 2 or more, les may be the same as or different from each other.

R¹ is preferably a hydrogen atom, an alkyl group, an alkoxy group or a halogen atom; more preferably a hydrogen atom, an alkyl group or a halogen atom (e.g., a fluorine atom, a chlorine atom, a bromine atom, and an iodine atom); and most preferably a hydrogen atom.

Ar², Ar³ and n are synonymous with those in formula (I), respectively, and the preferable examples are also the same.

Among dichroic dyes represented by formula (I), dichroic dyes represented by formula (III) are especially preferable. The dichroic dye represented by formula (III) is described below.

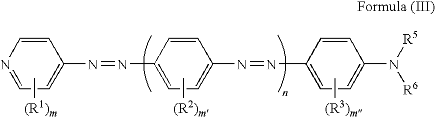

In formula (III), R¹, R², R³, R⁵ and R⁶ each independently represent a substituent; n represents an integer of 1 or more; when n is an integer of 2 or more, R²s may be the same as or different from each other; m represents an integer of 0 to 4; when m is an integer of 2 or more, R¹s may be the same as or different from each other; m′ represents an integer of 0 to 4; when m′ is an integer of 2 or more, R²s may be the same as or different from each other; m″ represents an integer of 0 to 4; when m″ is an integer of 2 or more, R³s may be the same as or different from each other; when two or more than two R² or R³ are present, a plurality of R² or R³ may bond to each other to form a ring respectively; and R³, R⁵, and R⁶ may bond to each other to form a ring.

In formula (III), R¹ has the same meaning as the substituent described with respect to R¹ in formula (II), and the preferable examples are also the same.

In formula (III), R² has the same meaning as the substituent described with respect to the substituent which may be possessed by Ar² in formula (I), and the preferable examples are also the same. R² is most preferably a methyl group.

In formula (III), R³ has the same meaning as the substituent described with respect to the substituent which may be possessed by Ar³ in formula (I), and the preferable examples are also the same.

R⁵ and R⁶ each are preferably a hydrogen atom, an alkyl group, an acyl group, an alkoxycarbonyl group, or a sulfonyl group; more preferably a hydrogen atom or an alkyl group; and most preferably an alkyl group.

The alkyl group in this occasion is an alkyl group preferably having 1 to 20 carbon atoms, more preferably having 1 to 12 carbon atoms and particularly preferably having 1 to 6 carbon atoms.

The acyl group in this occasion is an acyl group preferably having 1 to 20 carbon atoms, and particularly preferably having 1 to 12 carbon atoms.

The alkoxycarbonyl group in this occasion is an alkoxycarbonyl group preferably having 2 to 20 carbon atoms, and particularly preferably having 2 to 12 carbon atoms.

The sulfonyl group in this occasion is a sulfonyl group preferably having 1 to 20 carbon atoms, and particularly preferably having 1 to 12 carbon atoms.

The above-described substituent may have a substituent. This optional substituent has the same meaning as those groups listed as the substituent with which an alkyl group of the substituent which may be possessed by Ar² in formula (I) may be substituted. The preferable examples are also the same.

n represents an integer of 1 or more; preferably an integer of 1 to 10; and further preferably an integer of 1 to 3.

Further, the case where one of R⁵ or R⁶, or both R⁵ and R⁶ bond to R³ to form a ring is also preferable. In this case, the ring is preferably a 5- to 7-membered ring, and more preferably a 5- to 6-membered ring.

Specific examples of the azo dye represented by formula (II) are shown below, but the present invention is not restricted thereby. The mark “*” in the following formulae indicates the binding site to the azo group.

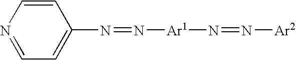

| Exemplified | | |
|---|---|---|
| compound No. | Ar¹ | Ar² |
| A-1 | 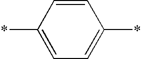 | 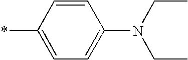 |
| A-2 | 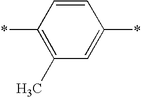 | 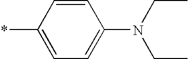 |
| A-3 | 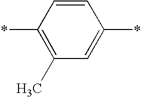 | 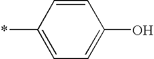 |
| A-4 | 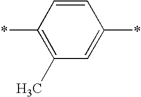 | 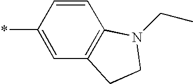 |

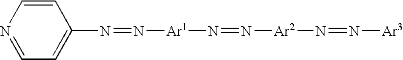

| Exemplified | | | |
|---|---|---|---|
| compound No. | Ar¹ | Ar² | Ar³ |
| A-5 | 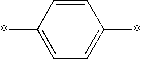 | 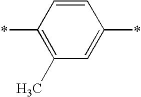 | 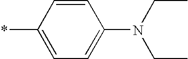 |
| A-6 | 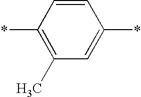 | 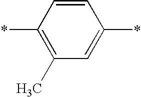 | 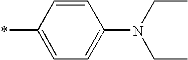 |
| A-7 | 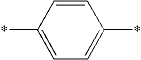 | 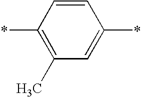 | 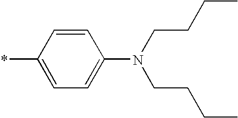 |
| A-8 | 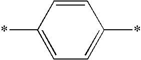 | 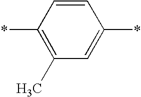 | 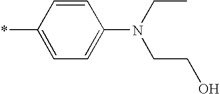 |
| A-9 | 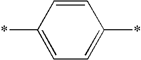 | 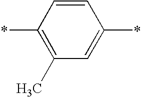 | 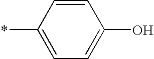 |
| A-10 | 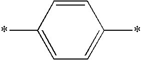 | 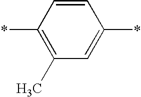 | 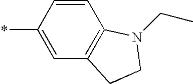 |
| A-11 | 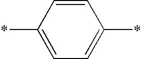 | 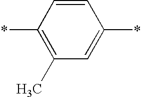 | 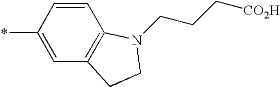 |

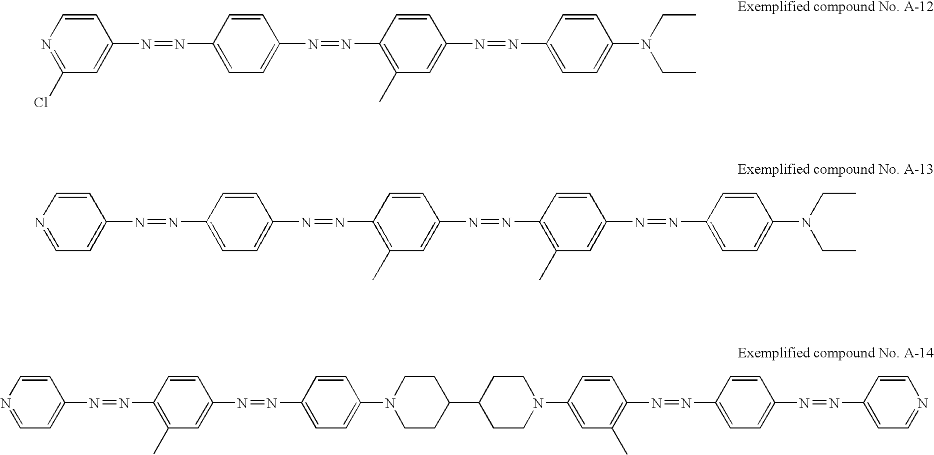

As the liquid crystalline dichroic azo dye represented by formula (I), dichroic dyes represented by formula (IV) are also exemplified.

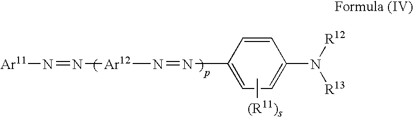

In formula (IV), R¹¹, R¹² and R¹³, each independently represent a hydrogen atom or a substituent; Ar¹¹ is a substituted or unsubstituted phenyl group, a substituted or unsubstituted naphthyl group, or a substituted or unsubstituted aromatic heterocyclic group excluding pyridyl group; Ar¹² is a divalent substituted or unsubstituted aromatic hydrocarbon group or a divalent substituted or unsubstituted aromatic heterocyclic group; s represents an integer of 0 to 4; when s is an integer of 2 or more, R¹¹s may be the same as or different from each other; p represents an integer of 1 to 5; when p is an integer of 2 or more, Ar¹²s may be the same as or different from each other; and at least one of Ar¹²s represents a phenylene group having an alkyl group.

R¹¹, R¹² and R¹³ each independently represent a hydrogen atom, or a substituent. Examples of the substituent include those groups listed as a substituent with which each of Ar¹, Ar² and Ar³ in formula (I) may be substituted. s represents an integer of 0 to 4; preferably an integer of 0 to 2.

R¹¹ is preferably a hydrogen atom, an alkyl group, an alkoxy group or a halogen atom; more preferably a hydrogen atom, an alkyl group or an alkoxy group; and most preferably a hydrogen atom. R¹² and R¹³ each are preferably a hydrogen atom or an alkyl group; and most preferably an alkyl group.

Ar¹¹ is a substituted or unsubstituted phenyl group, a substituted or unsubstituted naphthyl group, or a substituted or unsubstituted aromatic heterocyclic group excluding pyridyl group.

With regard to the substituent which may be possessed by the phenyl group or the naphthyl group, a group which is introduced in order to raise a solubility of the azo compound, a group having an electron donative property or an electron withdrawing property which is introduced in order to adjust color tone as a dye, or a group having the polymerizable group which is introduced in order to fixate an orientation is preferable. Specific examples include a substituent represented by R¹¹, R¹² or R¹³. Preferred examples of the substituent include a substituted or unsubstituted alkyl group, a substituted or unsubstituted alkenyl group, a substituted or unsubstituted alkynyl group, a substituted or unsubstituted aryl group, a substituted or unsubstituted alkoxy group, a substituted or unsubstituted alkoxycarbonyl group, a substituted or unsubstituted acyloxy group, a substituted or unsubstituted acylamino group, a substituted or unsubstituted amino group, a substituted or unsubstituted alkoxycarbonylamino group, a substituted or unsubstituted sulfonylamino group, a substituted or unsubstituted sulfamoyl group, a substituted or unsubstituted carbamoyl group, a substituted or unsubstituted alkylthio group, a substituted or unsubstituted sulfonyl group, a substituted or unsubstituted ureido group, a nitro group, a hydroxy group, a cyano group and a halogen atom.

The alkyl group is an alkyl group having preferably from 1 to 20 carbon atoms, more preferably from 1 to 12 carbon atoms. Examples of the group which may be substituted on the alkyl group include an alkoxy group, an acyloxy group, a hydroxy group and a halogen atom.

The group which may be substituted on the alkyl group is preferably a polymerizable group. Examples of the polymerizable group include the same as examples of the polymerizable group described with respect to Ar² in formula (I), and preferable examples thereof are also the same as preferable examples of the polymerizable group described with respect to Ar².

The alkenyl group is an alkenyl group having preferably from 2 to 20 carbon atoms, more preferably from 2 to 12 carbon atoms. The group which may be substituted on the alkenyl group is synonymous with the group which may be substituted on the alkyl group and the preferable examples are also the same.

The alkynyl group is an alkynyl group having preferably from 2 to 20 carbon atoms, more preferably from 2 to 12 carbon atoms. The group which may be substituted on the alkynyl group is synonymous with the group which may be substituted on the alkyl group and the preferable examples are also the same.

The aryl group is an aryl group having preferably from 6 to 20 carbon atoms, more preferably from 6 to 12 carbon atoms. The group which may be substituted on the aryl group is synonymous with the group which may be substituted on the alkyl group and the preferable examples are also the same.

The alkoxy group is an alkoxy group having preferably from 1 to 20 carbon atoms, more preferably from 1 to 12 carbon atoms. The group which may be substituted on the alkoxy group is synonymous with the group which may be substituted on the alkyl group and the preferable examples are also the same.

The alkoxycarbonyl group is an alkoxycarbonyl group having preferably from 2 to 20 carbon atoms, more preferably from 2 to 12 carbon atoms. The group which may be substituted on the alkoxycarbonyl group is synonymous with the group which may be substituted on the alkyl group and the preferable examples are also the same.

The acyloxy group is an acyloxy group having preferably from 2 to 20 carbon atoms, more preferably from 2 to 12 carbon atoms. The group which may be substituted on the acyloxy group is synonymous with the group which may be substituted on the alkyl group and the preferable examples are also the same.

The amino group is an amino group having preferably from 1 to 20 carbon atoms, more preferably from 1 to 12 carbon atoms. The group which may be substituted on the amino group is synonymous with the group which may be substituted on the alkyl group and the preferable examples are also the same.

The acylamino group is an acylamino group having preferably from 1 to 20 carbon atoms, more preferably from 1 to 12 carbon atoms. The group which may be substituted on the acylamino group is synonymous with the group which may be substituted on the alkyl group and the preferable examples are also the same.

The alkoxycarbonylamino group is an acylamino group having preferably from 2 to 20 carbon atoms, more preferably from 2 to 12 carbon atoms. The group which may be substituted on the alkoxycarbonylamino group is synonymous with the group which may be substituted on the alkyl group and the preferable examples are also the same.

The sulfonylamino group is a sulfonylamino group having preferably from 1 to 20 carbon atoms, more preferably from 1 to 12 carbon atoms. The group which may be substituted on the sulfonylamino group is synonymous with the group which may be substituted on the alkyl group and the preferable examples are also the same.

The sulfamoyl group is a sulfamoyl group having preferably from 1 to 20 carbon atoms, more preferably from 1 to 12 carbon atoms. The group which may be substituted on the sulfamoyl group is synonymous with the group which may be substituted on the alkyl group and the preferable examples are also the same.

The group which may be substituted on the carbamoyl group is synonymous with the group which may be substituted on the alkyl group and the preferable examples are also the same.

The alkylthio group is an alkylthio group having preferably from 1 to 20 carbon atoms, more preferably from 1 to 12 carbon atoms. The group which may be substituted on the alkylthio group is synonymous with the group which may be substituted on the alkyl group and the preferable examples are also the same.

The sulfonyl group is a sulfonyl group having preferably from 1 to 20 carbon atoms, more preferably from 1 to 12 carbon atoms. The group which may be substituted on the sulfonyl group is synonymous with the group which may be substituted on the alkyl group and the preferable examples are also the same.

The ureido group is an ureido group having preferably from 2 to 20 carbon atoms, more preferably from 2 to 12 carbon atoms. The group which may be substituted on the ureido group is synonymous with the group which may be substituted on the alkyl group and the preferable examples are also the same.

The phenyl group or the naphthyl group may have these substituents in numbers of 1 to 5, preferably 1 or 2.

The aromatic heterocyclic group is preferably a group having a heterocyclic origin of single ring or double rings. Examples of the atom excluding a carbon atom which composes the aromatic heterocyclic group include a nitrogen atom, a sulfur atom and an oxygen atom. When the aromatic heterocyclic group has a plurality of atom excluding the carbon atom, those atoms may be the same with, or different from each other. Specific examples of the aromatic heterocyclic group include a quinolyl group, a thiazolyl group, a benzothiazolyl group, a quinolonyl group, a naphthalimidoyl group, and a group having a heterocyclic origin as shown below.

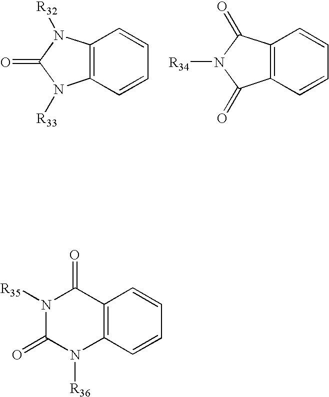

R₃₂, R₃₃, R₃₄, R₃₅ and R₃₆ each independently represent a hydrogen atom, a substituted or unsubstituted alkyl group, or a substituted or unsubstituted phenyl group. The substituent on the alkyl group and the phenyl group is synonymous with the substituent which may be substituted on the alkyl group and the preferable examples are also the same.

A quinolyl group or a phthalimide-yl group is preferable as the aromatic heterocyclic group.

Ar¹¹ is particularly preferably a substituted or unsubstituted phenyl group.

Ar¹² represents a divalent substituted or unsubstituted aromatic hydrocarbon group or a divalent substituted or unsubstituted aromatic heterocyclic group.

The aromatic hydrocarbon group represented by Ar¹² is preferably a phenylene group or a naphthylene group. Examples of the substituent which the aromatic hydrocarbon group may have include a substituted or unsubstituted alkyl group, a substituted or unsubstituted alkoxy group, a hydroxy group, a nitro group, a halogen atom, a substituted or unsubstituted amino group, a substituted or unsubstituted acylamino group, and a cyano group. Additionally, a preferable number of carbon atoms and the substituent which may be possessed in the substituted alkyl group, the substituted alkoxy group, the substituted amino group and the substituted acylamino group are synonymous with that described in the case of the above-mentioned A₁ being the phenyl group or the naphthyl group, and the preferable examples are also the same.

The aromatic heterocyclic group represented by Ar¹² is preferably a group having a heterocyclic origin of single ring or double rings. Examples of the atom composing the aromatic heterocyclic group excluding the carbon atom include a nitrogen atom, a sulfur atom and an oxygen atom, and the nitrogen atom is particularly preferable. When the aromatic heterocyclic group has a plurality of atom excluding the carbon atom, those atoms may be the same with, or different from each other. Specific examples of the aromatic heterocyclic group include a pyridinediyl group, a quinolinediyl group, an isoquinolinediyl group, a benzothiadiazolediyl group, and a phthalimidediyl group. Among those, a quinolinediyl group and an isoquinolinediyl group are preferable.

Examples of the substituent which may be possessed by the aromatic heterocyclic group include an alkyl group such as a methyl group and an ethyl group, an alkoxy group such as a methoxy group and an ethoxy group, an amino group such as an unsubstituted amino group and a methylamino group, an acetylamino group, an acylamino group, a nitro group, a hydroxy group, a cyano group and a halogen atom.

Ar¹² is particularly preferably a divalent substituted or unsubstituted phenylene group.

p represents an integer of 1 to 5, and preferably in integer of 2 to 4.

The nematic phase transition temperature of the compound represented by formula (IV) is preferably 80° C. or higher and lower than 150° C., more preferably 100° C. or higher and lower than 150° C.

The specific examples of the azo dye represented by formula (IV) are shown below. However, the present invention is not limited to these specific examples.

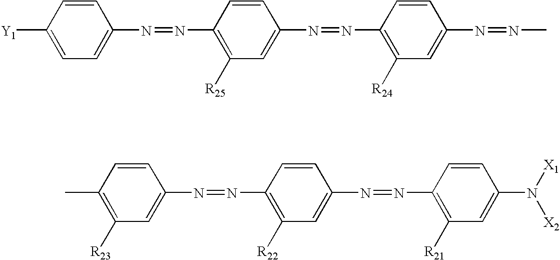

| No. | X₁ | X₂ | R₂₁ | R₂₂ | R₂₃ | R₂₄ | R₂₅ | Y₁ |
|---|---|---|---|---|---|---|---|---|
| B-1 | —C₂H₅ | —C₂H₅ | —H | —CH₃ | —H | —H | —H | —C₄H₉ |
| B-2 | —C₂H₅ | —C₂H₅ | —H | —CH₃ | —CH₃ | —CH₃ | —H | —C₄H₉ |
| B-3 | —CH₃ | —CH₃ | —H | —CH₃ | —H | —H | —H | —C₄H₉ |

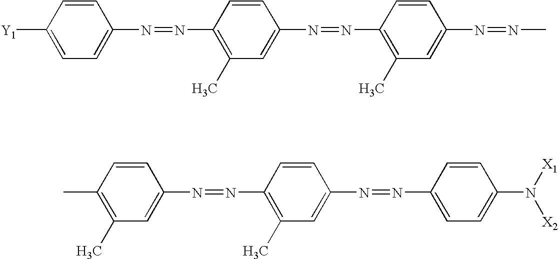

| No. | X₁ | X₂ | Y₁ |
|---|---|---|---|
| B-4 | —C₂H₅ | —C₂H₅ | 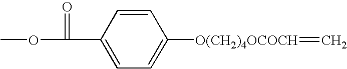 |
| B-5 | —C₂H₅ | —C₂H₅ | 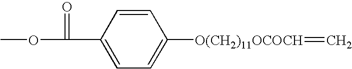 |
| B-6 | —CONH(CH₂)₂OCOC(CH₃)═CH₂ | —H | —C₄H₉ |
| B-7 | —CONH(CH₂)₂OCOC(CH₃)═CH₂ | —C₂H₅ | —C₄H₉ |
| B-8 | —CONH(CH₂)₂OCOC(CH₃)═CH₂ | —C₂H₅ | 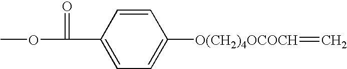 |

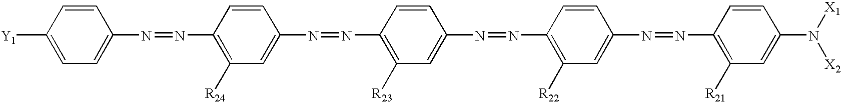

| No. | X₁ | X₂ | R₂₁ | R₂₂ | R₂₃ | R₂₄ | Y₁ |
|---|---|---|---|---|---|---|---|
| B-9 | —C₂H₅ | —C₂H₅ | —H | —CH₃ | —H | —H | —C₄H₉ |
| B-10 | —C₂H₅ | —C₂H₅ | —CH₃ | —CH₃ | —H | —H | —C₄H₉ |
| B-11 | —C₂H₅ | —C₂H₅ | —H | —CH₃ | —CH₃ | —CH₃ | —C₄H₉ |
| B-12 | —CONH(CH₂)₂OCOC(CH₃)═CH₂ | —H | —H | —CH₃ | —H | —H | —C₄H₉ |
| B-13 | —CONH(CH₂)₂OCOC(CH₃)═CH₂ | —C₂H₅ | —H | —CH₃ | —H | —H | —C₄H₉ |
| B-14 | —CONH(CH₂)₂OCOC(CH₃)═CH₂ | —C₂H₅ | —H | —CH₃ | —CH₃ | —CH₃ | 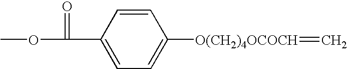 |
| B-15 | —C₂H₅ | —C₂H₅ | —H | —CH₃ | —CH₃ | —CH₃ | 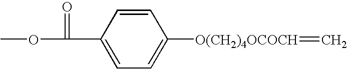 |

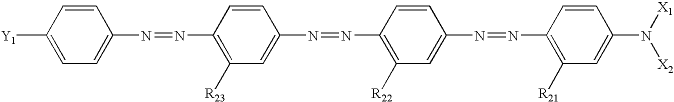

| No. | X₁ | X₂ | R₂₁ | R₂₂ | R₂₃ | Y₁ |
|---|---|---|---|---|---|---|
| B-16 | —C₂H₅ | —C₂H₅ | —H | —CH₃ | —H | —C₄H₉ |
| B-17 | —C₂H₅ | —C₂H₅ | —H | —CH₃ | —CH₃ | —C₄H₉ |
| B-18 | —C₂H₅ | —C₂H₅ | —H | —CH₃ | —H | 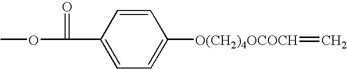 |
| B-19 | —C₂H₅ | —C₂H₅ | —H | —CH₃ | —H | 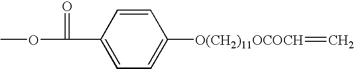 |
| B-20 | —CONH(CH₂)₂OCOC(CH₃)═CH₂ | —H | —H | —CH₃ | —H | —C₄H₉ |
| B-21 | —CONH(CH₂)₂OCOC(CH₃)═CH₂ | —C₂H₅ | —H | —CH₃ | —H | —C₄H₉ |
| B-22 | —CONH(CH₂)₂OCOC(CH₃)═CH₂ | —C₂H₅ | —H | —CH₃ | —H | 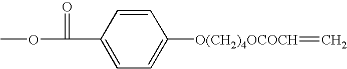 |
| B-23 | —CONH(CH₂)₂OCOC(CH₃)═CH₂ | —C₂H₅ | —H | —CH₃ | —H | 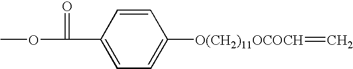 |
| B-24 | —C₂H₅ | —C₂H₅ | —OCH₃ | —CH₃ | —H | —C₄H₉ |
| B-25 | —C₂H₅ | —C₂H₅ | —H | —CH₃ | —CH₃ | 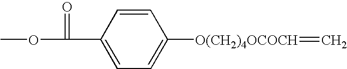 |
| B-26 | —CONH(CH₂)₂OCOC(CH₃)═CH₂ | —C₂H₅ | —H | —CH₃ | —CH₃ | 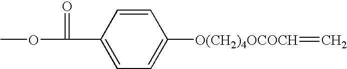 |

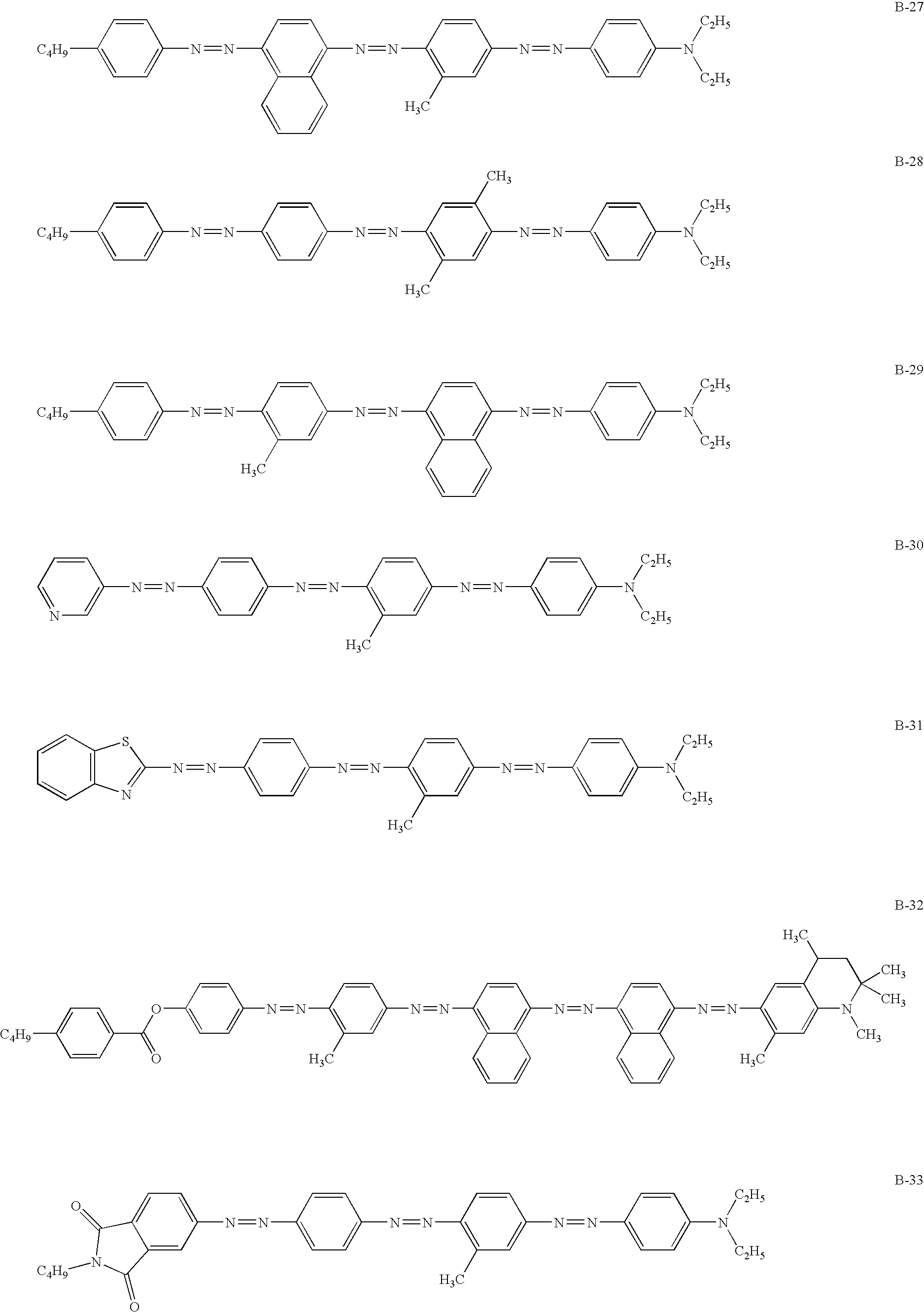

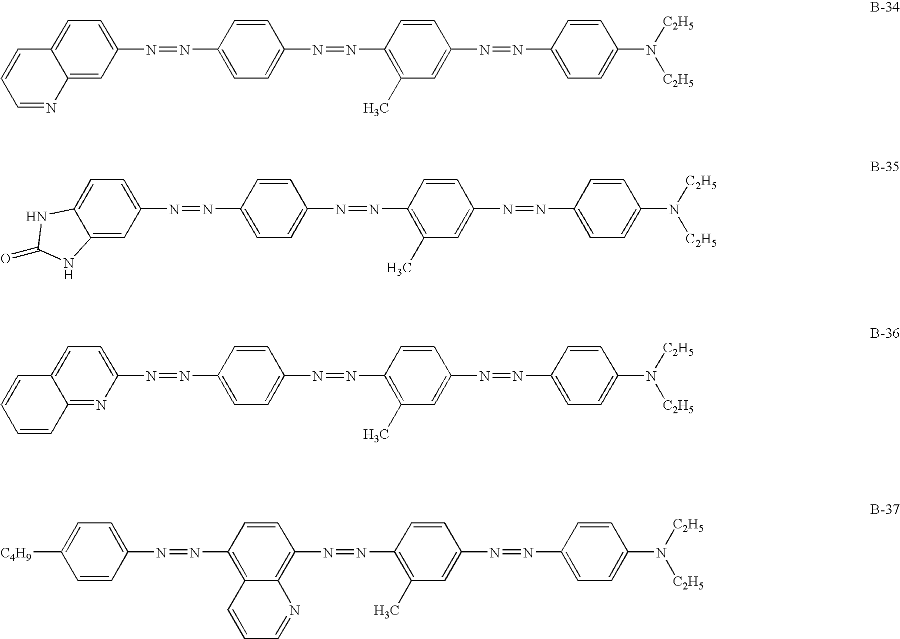

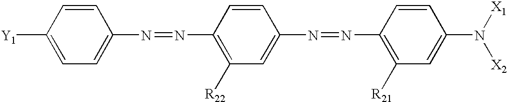

| No. | X₁ | X₂ | R₂₁ | R₂₂ | Y₁ |
|---|---|---|---|---|---|
| B-38 | —C₂H₅ | —C₂H₅ | —H | —CH₃ | 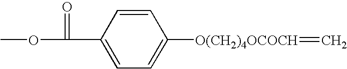 |
| B-39 | —CONH(CH₂)₂OCOC(CH₃)═CH₂ | —C₂H₅ | —H | —CH₃ | 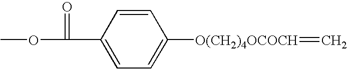 |
| B-40 | —C₂H₅ | —C₂H₅ | —H | —CH₃ | —C₄H₉ |

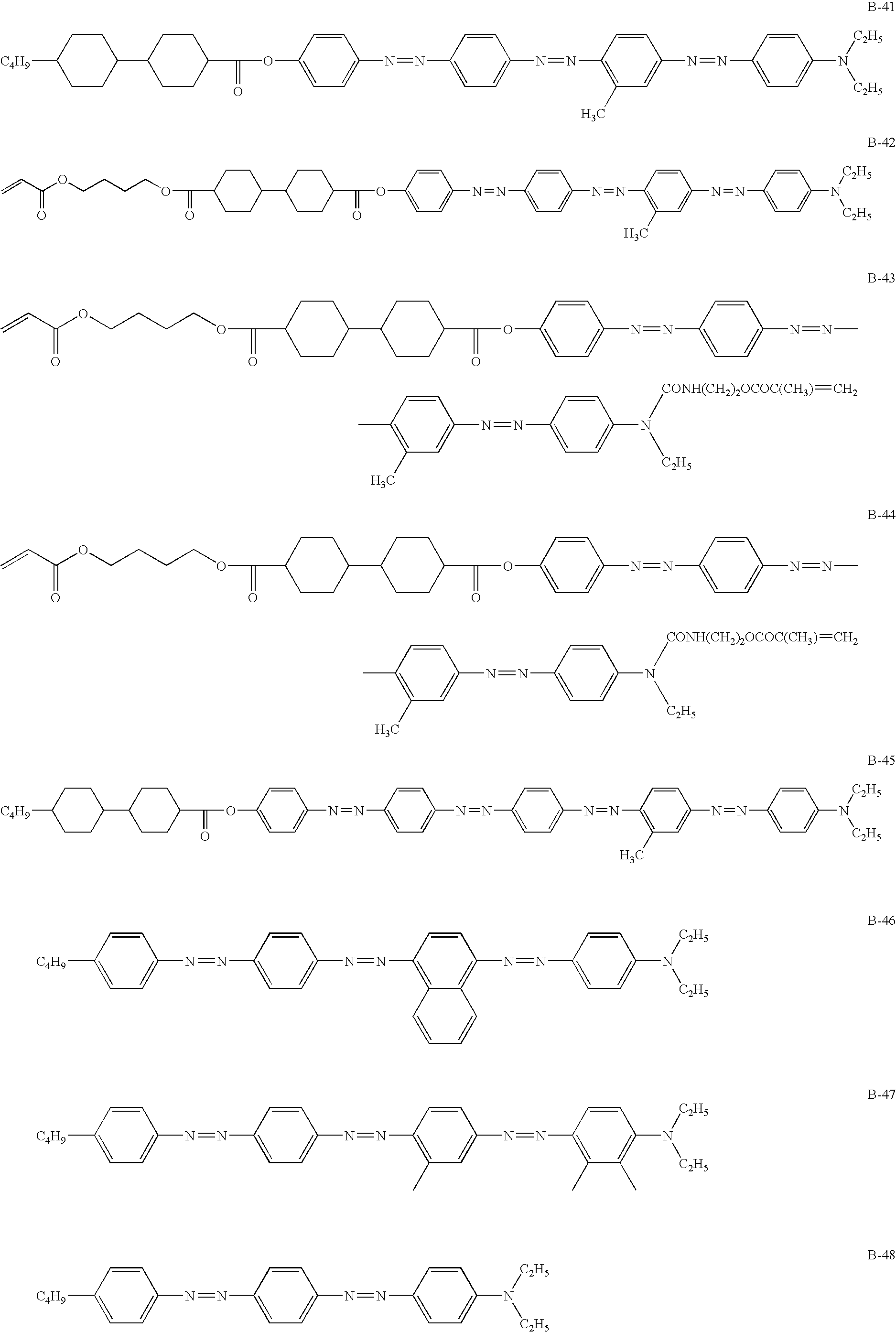

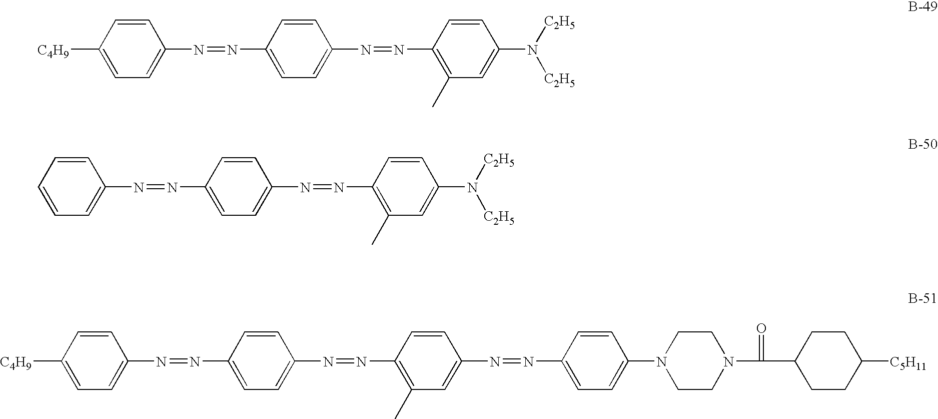

The azo dye represented by formula (IV) is particularly preferably the azo dye represented by formula (V).

The azo dye represented by formula (V) is described below.

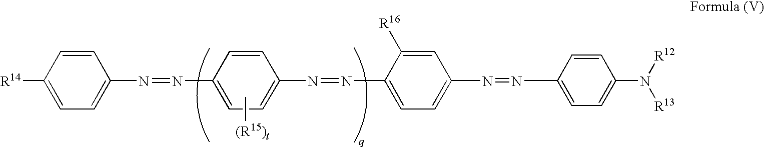

In formula (V), R¹², R¹³ and R¹⁵ each independently represent a hydrogen atom or a substituent; R¹⁴ represents a substituted or unsubstituted, alkyl group, alkenyl group, alkynyl group, aryl group, alkoxy group, alkoxycarbonyl group, acyloxy group, acylamino group, alkoxycarbonylamino group, sulfonylamino group, sulfamoyl group, carbamoyl group, alkylthio group, sulfonyl group or ureido group; R¹⁶ represents an alkyl group; t represents an integer of 0 to 4; when t is an integer of 2 or more, R¹⁵s may be the same as or different from each other; and q represents an integer of 1 to 3.

The substituent represented by R¹², R¹³ and R¹⁵ is synonymous with the substituent of R¹² and R¹³ in formula (IV), and the preferred examples are also the same. The substituent represented by R¹², R¹³ and R¹⁵ is preferably a methyl group or an ethyl group. The alkyl group represented by R¹⁶ is most preferably a methyl group.

The substituent represented by R¹⁵ is synonymous with the substituent of Ar¹² in formula (IV), and the preferred examples are also the same.

The substituted or unsubstituted, alkyl group, alkenyl group, alkynyl group, aryl group, alkoxy group, alkoxycarbonyl group, acyloxy group, acylamino group, alkoxycarbonylamino group, sulfonylamino group, sulfamoyl group, carbamoyl group, alkylthio group, sulfonyl group or ureide group represented by R¹⁴ is synonymous with the alkyl group, the alkenyl group, the alkynyl group, the aryl group, the alkoxy group, the alkoxycarbonyl group, the acyloxy group, the acylamino group, the alkoxycarbonylamino group, the sulfonylamino group, the sulfamoyl group, the carbamoyl group, the alkylthio group, the sulfonyl group or the ureide group which is a substituent of the group represented by Ar¹¹ in formula (IV), and the preferred examples are also the same. R¹⁴ is preferably an alkyl group, an aryl group, an alkoxy group, an alkoxycarbonyl group, an acyloxy group, an acylamino group, a sulfonylamino group, a sulfamoyl group, a carbamoyl group, an alkylthio group or a sulfonyl group; more preferably an alkyl group, an aryl group, an alkoxy group, an alkoxycarbonyl group, an acyloxy group or an alkylthio group; and most preferably an alkyl group, an aryl group or an alkoxy group.

As the azo dye represented by formula (I), compounds listed below are also exemplified.

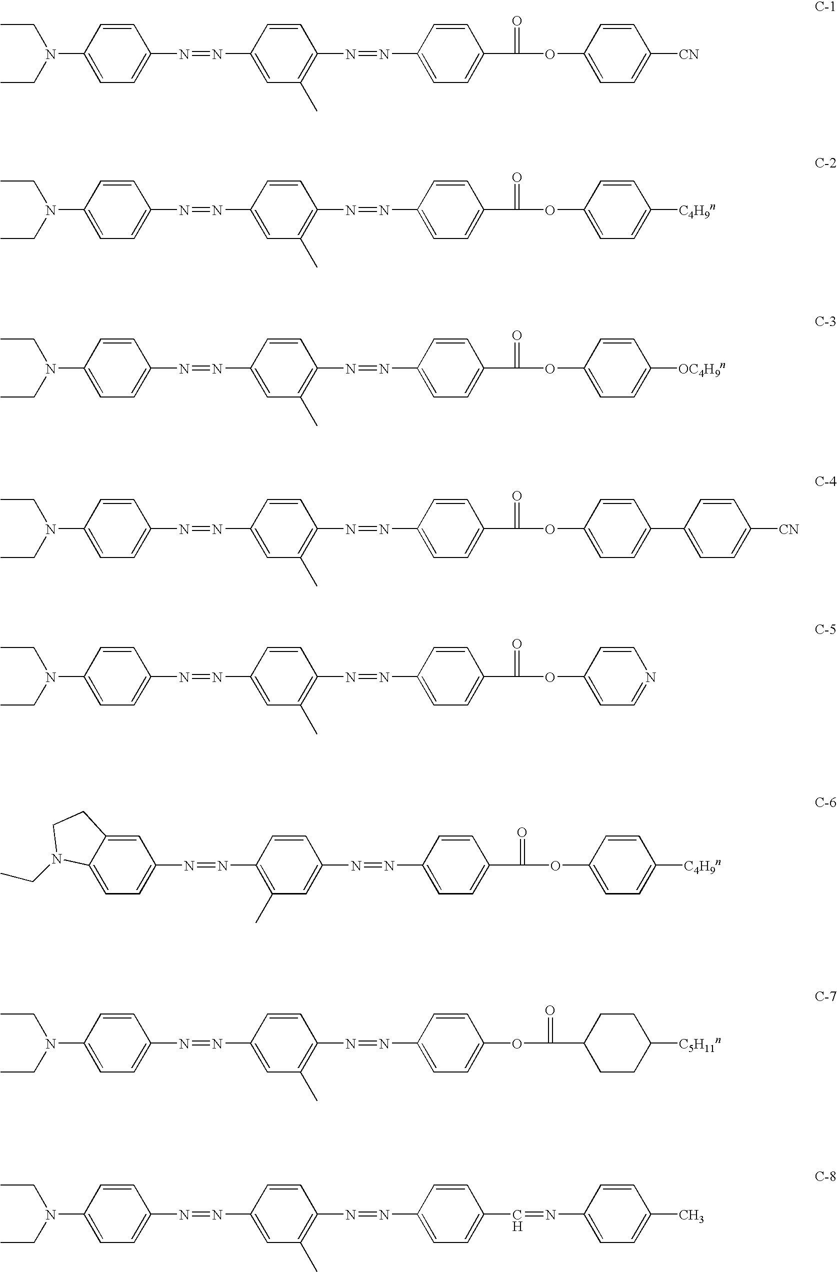

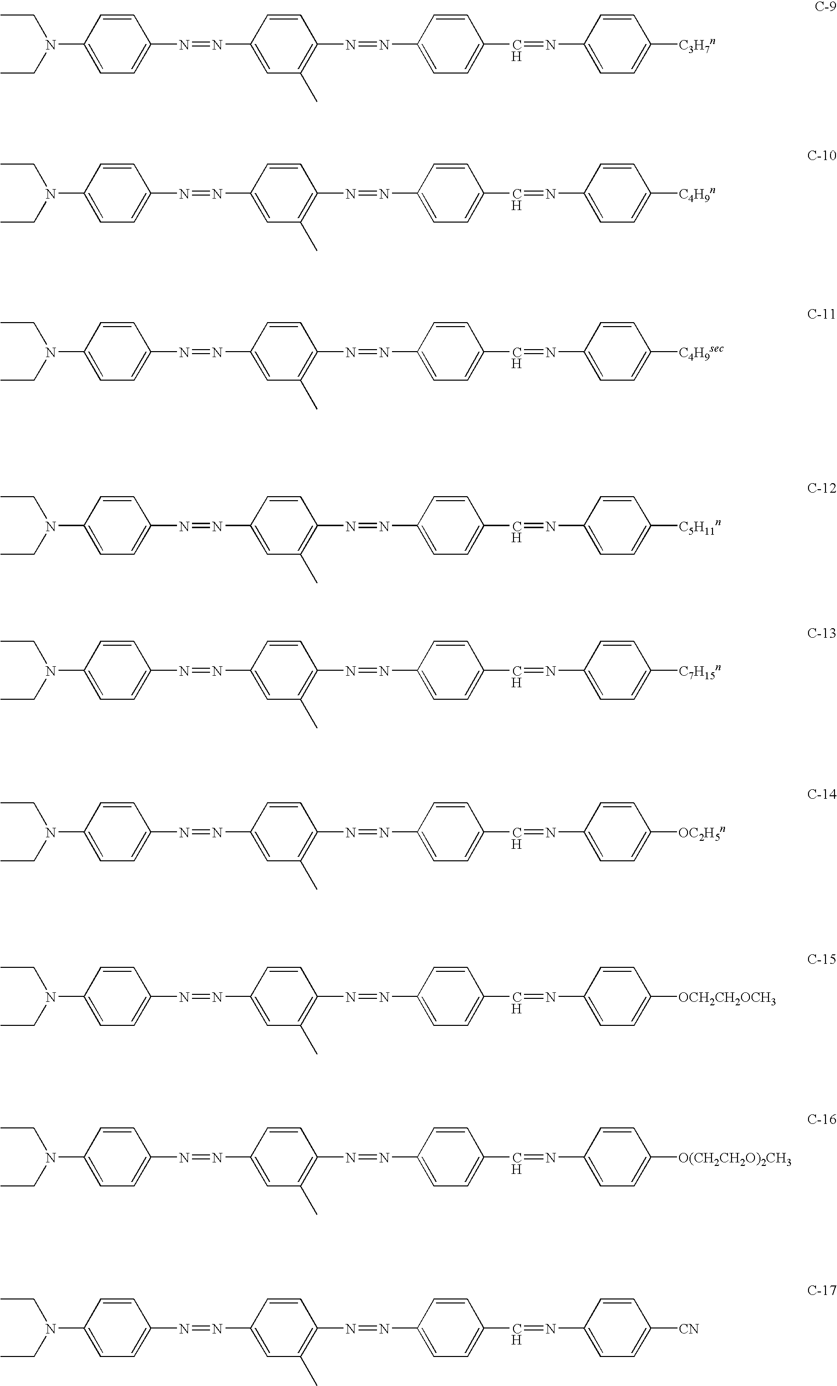

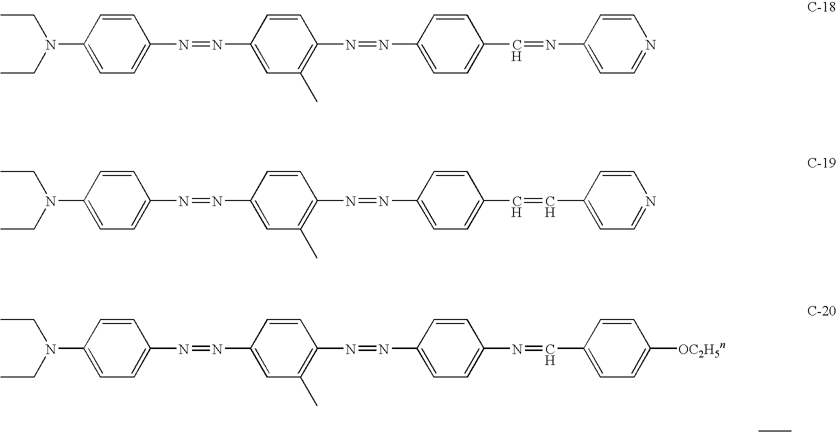

The liquid crystalline composition of the present invention contains a dichroic azo dye that is represented by formula (I) and has the above-described specific nematic phase transition temperature, and further together therewith contains at least one of other liquid crystalline dichroic azo dyes that do not satisfy with the above-described requirements. In other words, the liquid crystalline composition of the present invention contains at least one of azo dyes that is represented by formula (I) and has the nematic phase transition temperature of 80° C. or higher and lower than 150° C., or at least one of azo dyes not represented by formula (I).

Examples of the azo dyes not represented by formula (I) include an azo dye represented by formula (VI).

Ar²¹-N═N-Ar²²-L²¹-Ar²³-L²²-Ar²⁴ Formula (VI)

In formula (VI), Ar²¹ and Ar²⁴ each independently represent a substituted or unsubstituted, aromatic hydrocarbon ring group, aromatic heterocyclic group, or cyclohexyl group; Ar²² and Ar²³ each independently represent a divalent substituted or unsubstituted aromatic hydrocarbon group, a divalent substituted or unsubstituted aromatic heterocyclic group, or substituted or unsubstituted, cyclohexylene group; L²¹ is a carbonyloxy group, an oxycarbonyl group, an imino group, or a vinylene group; L²² is an azo group, a carbonyloxy group, an oxycarbonyl group, an imino group, or a vinylene group.

In formula (VI), Ar²¹ is preferably a substituted or unsubstituted aromatic hydrocarbon ring group, or a substituted or unsubstituted aromatic heterocyclic group, more preferably a substituted or unsubstituted naphthyl group, or a substituted or unsubstituted phenyl group, further preferably a substituted or unsubstituted phenyl group.

Preferable examples of the substituent which may be substituted on Ar²¹ in formula (VI) include a substituted or unsubstituted amino group (preferably an amino group having from 0 to 20 carbon atoms, more preferably from 0 to 10 carbon atoms, particularly preferably from 0 to 6 carbon atoms, e.g., an unsubstitued amino group, a methylamino group, a dimethylamino group, a diethylamino group, an anilino group), a hydroxy group, an alkoxy group (preferably an alkoxy group having from 1 to 20, more preferably from 1 to 10, and particularly preferably from 1 to 6 carbon atoms, e.g., a methoxy group, an ethoxy group, a butoxy group). Among those, a substituted or unsubstituted amino group is more preferably. In particular, Ar²¹ is preferably a phenyl group, which has a substituted or unsubstituted amino group positioned at the para position with respect to the azo group, and which has no substituent at the positions other than the para position.

In formula (VI), Ar²² is preferably a divalent substituted or unsubstituted aromatic hydrocarbon group, or a divalent substituted or unsubstituted aromatic heterocyclic group, more preferably a substituted or unsubstituted, phenylene group or naphthylene group, further preferably a substituted or unsubstituted phenylene group.

Preferable examples of the substituent which may be substituted on Ar²² in formula (VI) include a substituted or unsubstituted alkyl group (preferably an alkyl group having from 1 to 20, more preferably from 1 to 12, and particularly preferably from 1 to 8 carbon atoms, e.g., a methyl group, an ethyl group, a propyl group, an iso-propyl group, a butyl group, an iso-butyl group, a tert-butyl group, an n-octyl group, an n-decyl group, an n-hexadecyl group, a cyclopropyl group, a cyclopentyl group, a cyclohexyl group), an alkoxy group (preferably an alkoxy group having from 1 to 20, more preferably from 1 to 10, and particularly preferably from 1 to 6 carbon atoms, e.g., a methoxy group, an ethoxy group, a butoxy group), an alkylene oxy group (preferably an ethyleneoxy group or propyleneoxy group, more preferably an ethyleneoxy group represented by —(OCH₂CH₂)nOX (n represents an integer of 1 to 10, preferably 1 to 6, more preferably 1 to 3, and X represents a hydrogen atom or an alkyl group having from 1 to 3 carbon atoms)), a halogen atom (e.g., a fluorine atom, a chlorine atom, a bromine atom, or an iodine atom), or a hydroxyl group. Among those, an alkyl group, an alkoxy group, and an alkylene oxy group are more preferably. Ar²² is particularly preferably an unsubstituted phenylene group, or a phenylene group substituted by an alkyl group.

In formula (VI), Ar²³ is preferably a substituted or unsubstituted, phenylene group or naphthylene group, more preferably a substituted or unsubstituted phenylene group. Examples of the substituent which may be substituted on Ar²³ include the same as examples of the substituent which may be substituted on Ar²², and preferable examples thereof are also the same as preferable examples of the substituent which may be substituted on Ar²².

In formula (VI), Ar²⁴ is preferably a substituted or unsubstituted, phenyl group, naphthyl group, or pyridyl group, more preferably a substituted or unsubstituted, phenyl group or pyridyl group.

Preferable examples of the substituent which may be substituted on Ar²⁴ in formula (VI) include a substituted or unsubstituted alkyl group (preferably an alkyl group having from 1 to 20, more preferably from 1 to 12, and particularly preferably from 1 to 8 carbon atoms, e.g., a methyl group, an ethyl group, a propyl group, an iso-propyl group, a butyl group, an iso-butyl group, a tert-butyl group, an n-octyl group, an n-decyl group, an n-hexadecyl group, a cyclopropyl group, a cyclopentyl group, a cyclohexyl group), an alkenyl group (preferably an alkenyl group having from 2 to 20, more preferably from 2 to 12, and particularly preferably from 2 to 8 carbon atoms, e.g., a vinyl group, an allyl group, a 2-butenyl group, a 3-pentenyl group), an alkynyl group (preferably an alkynyl group having from 2 to 20, more preferably from 2 to 12, and particularly preferably from 2 to 8 carbon atoms, e.g., a propargyl group, a 3-pentynyl group), an aryl group (preferably an aryl group having from 6 to 30, more preferably from 6 to 20, and particularly preferably from 6 to 12 carbon atoms, e.g., a phenyl group, 2,6-diethylphenyl group, 3,5-di(trifluoromethyl)phenyl group, a naphthyl group, a biphenyl group), a substituted or unsubstituted amino group (preferably an amino group having from 0 to 20, more preferably from 0 to 10, and particularly preferably from 0 to 6 carbon atoms, e.g., an unsubstituted amino group, a methylamino group, a dimethylamino group, a diethylamino group, an anilino group), an alkoxy group (preferably an alkoxy group having from 1 to 20, more preferably from 1 to 10, and particularly preferably from 1 to 6 carbon atoms, e.g., a methoxy group, an ethoxy group, a butoxy group), an alkylene oxy group (preferably an ethyleneoxy group or propyleneoxy group, more preferably an ethyleneoxy group represented by —(OCH₂CH₂)nOX (n represents an integer of 1 to 10, preferably 1 to 6, more preferably 1 to 3, and X represents a hydrogen atom or an alkyl group having from 1 to 3 carbon atoms)), an alkoxycarbonyl group (preferably an alkoxycarbonyl group having from 2 to 20, more preferably from 2 to 10, and particularly preferably from 2 to 6 carbon atoms, e.g., a methoxycarbonyl group, an ethoxycarbonyl group), an acyloxy group (preferably an acyloxy group having from 2 to 20, more preferably from 2 to 10, and particularly preferably from 2 to 6 carbon atoms, e.g., an acetoxy group, a benzoyloxy group), an acylamino group (preferably an acylamino group having from 2 to 20, more preferably from 2 to 10, and particularly preferably from 2 to 6 carbon atoms, e.g., an acetylamino group, a benzoylamino group), an alkoxycarbonylamino group (preferably an alkoxycarbonylamino group having from 2 to 20, more preferably from 2 to 10, and particularly preferably from 2 to 6 carbon atoms, e.g., a methoxycarbonylamino group), an aryloxycarbonylamino group (preferably an aryloxycarbonylamino group having from 7 to 20, more preferably from 7 to 16, and particularly preferably from 7 to 12 carbon atoms, e.g., a phenyloxycarbonylamino group), a sulfonylamino group (preferably a sulfonylamino group having from 1 to 20, more preferably from 1 to 10, and particularly preferably from 1 to 6 carbon atoms, e.g., a methanesulfonylamino group, a benzenesulfonylamino group), a sulfamoyl group (preferably a sulfamoyl group having from 0 to 20, more preferably from 0 to 10, and particularly preferably from 0 to 6 carbon atoms, e.g., a sulfamoyl group, a methylsulfamoyl group, a dimethylsulfamoyl group, a phenylsulfamoyl group), a carbamoyl group (preferably a carbamoyl group having from 1 to 20, more preferably from 1 to 10, and particularly preferably from 1 to 6 carbon atoms, e.g., an unsubstituted carbamoyl group, a methylcarbamoyl group, a diethylcarbamoyl group, a phenylcarbamoyl group), an alkylthio group (preferably an alkylthio group having from 1 to 20, more preferably from 1 to 10, and particularly preferably from 1 to 6 carbon atoms, e.g., a methylthio group, an ethylthio group), an arylthio group (preferably an arylthio group having from 6 to 20, more preferably from 6 to 16, and particularly preferably from 6 to 12 carbon atoms, e.g., a phenylthio group), a sulfonyl group (preferably a sulfonyl group having from 1 to 20, more preferably from 1 to 10, and particularly preferably from 1 to 6 carbon atoms, e.g., a mesyl group, a tosyl group), a sulfinyl group (preferably a sulfinyl group having from 1 to 20, more preferably from 1 to 10, and particularly preferably from 1 to 6 carbon atoms, e.g., a methanesulfinyl group, a benzenesulfinyl group), a ureido group (preferably a ureido group having from 1 to 20, more preferably from 1 to 10, and particularly preferably from 1 to 6 carbon atoms, e.g., an unsubstituted ureido group, a methylureido group, a phenylureido group), a phosphoric acid amido group (preferably a phosphoric acid amido group having from 1 to 20, more preferably from 1 to 10, and particularly preferably from 1 to 6 carbon atoms, e.g., a diethylphosphoric acid amido group, a phenylphosphoric acid amido group), a hydroxy group, a mercapto group, a halogen atom (e.g., a fluorine atom, a chlorine atom, a bromine atom, or an iodine atom), a cyano group, a nitro group, a hydroxamic acid group, a sulfino group, a hydrazino group, an imino group, a heterocyclic group (preferably a heterocyclic group having from 1 to 30, and more preferably from 1 to 12 carbon atoms; containing, as a hetero atom(s), for example, a nitrogen atom, an oxygen atom, or a sulfur atom, and specifically, e.g., an imidazolyl group, a pyridyl group, a quinolyl group, a furyl group, a piperidyl group, a morpholino group, a benzoxazolyl group, a benzimidazolyl group, a benzthiazolyl group can be exemplified), and a silyl group (preferably a silyl group having 3 to 40, more preferably 3 to 30, and particularly preferably 3 to 24 carbon atoms, e.g. a trimethylsilyl group, a triphenylsilyl group). Among those, an alkyl group, an aryl group, an alkoxy group, an alkylene oxy group, an alkoxycarbonyl group, an acyloxy group, a halogen atom, a cyano group, a nitro group, and a substituted amino group are more preferably, and an alkyl group, an alkoxy group, an alkylene oxy group, a cyano group, and a substituted amino group are further preferably. These substituents may further be substituted. When two or more substituents are present, the substituents may be the same as or different from each other. Alternatively, they may bind to each other, forming a ring, if possible.

In particular, Ar²⁴ is preferably an unsubstituted pyridyl group, or a phenyl group having an alkyl, alkoxy, alkylene oxy, cyano, or substituted amino group at the para position with respect to the L²².

The compound represented by formula (VI) may be substituted by a polymerizable group. It is preferably to have the polymelizable group, since the hardness of the resultant film can be enhanced. Examples of the polymerizable group include an unsaturated polymerizable group, an epoxy group, and aziridinyl group. Among those, an unsaturated polymerizable group is preferable, and an ethylenically unsaturated polymerizable group is particularly preferable. Examples of the ethylenically unsaturated polymerizable group include an acryloyl group and a methacryloyl group.

It is preferably to have the polymelizable group to be positioned at the terminal in the compound. That is, it is preferably to have the polymelizable group to be positioned as a substituent on the Ar²¹ and/or Ar²⁴.

In formula (VI), L²¹ is a carbonyloxy group (—C(═O)O—), an oxycarbonyl group (—OC(═O)—), an imino group (—CH═N— or —N═CH—), or a vinylene group (—CH═CH—), preferably —C(═O)O—, —OC(═O)—, or —CH═N—, and more preferably —C(═O)O— or —CH═N—. L²² is an azo group (—N═N—), a carbonyloxy group (—C(═O)O—), an oxycarbonyl group (—OC(═O)—), an imino group (—CH═N— or —N═CH—), or a vinylene group (—CH═CH—), preferably —N═N—, —C(═O)O—, —OC(═O)—, —CH═N—, or —CH═CH—, and more preferably —N═N—, —C(═O)O—, or —CH═N—.

As the combination of L²¹ and L²², preferable examples include (L²¹/L²²)=(—C(═O)O—/—N═N—), (—C(═O)O—/—CH═CH—), and (—CH═N—/—N═N—); and more preferable examples include (L²¹/L²²)=(—C(═O)O—/—N═N—).

The nematic phase transition temperature of the compound represented by formula (VI) is preferably from 80° C. to 300° C., more preferably from 100° C. to 250° C.

Specific examples of the azo dyes represented by formula (VI) which may be used in the present invention are shown below, but the invention is not meant to be limited to these.

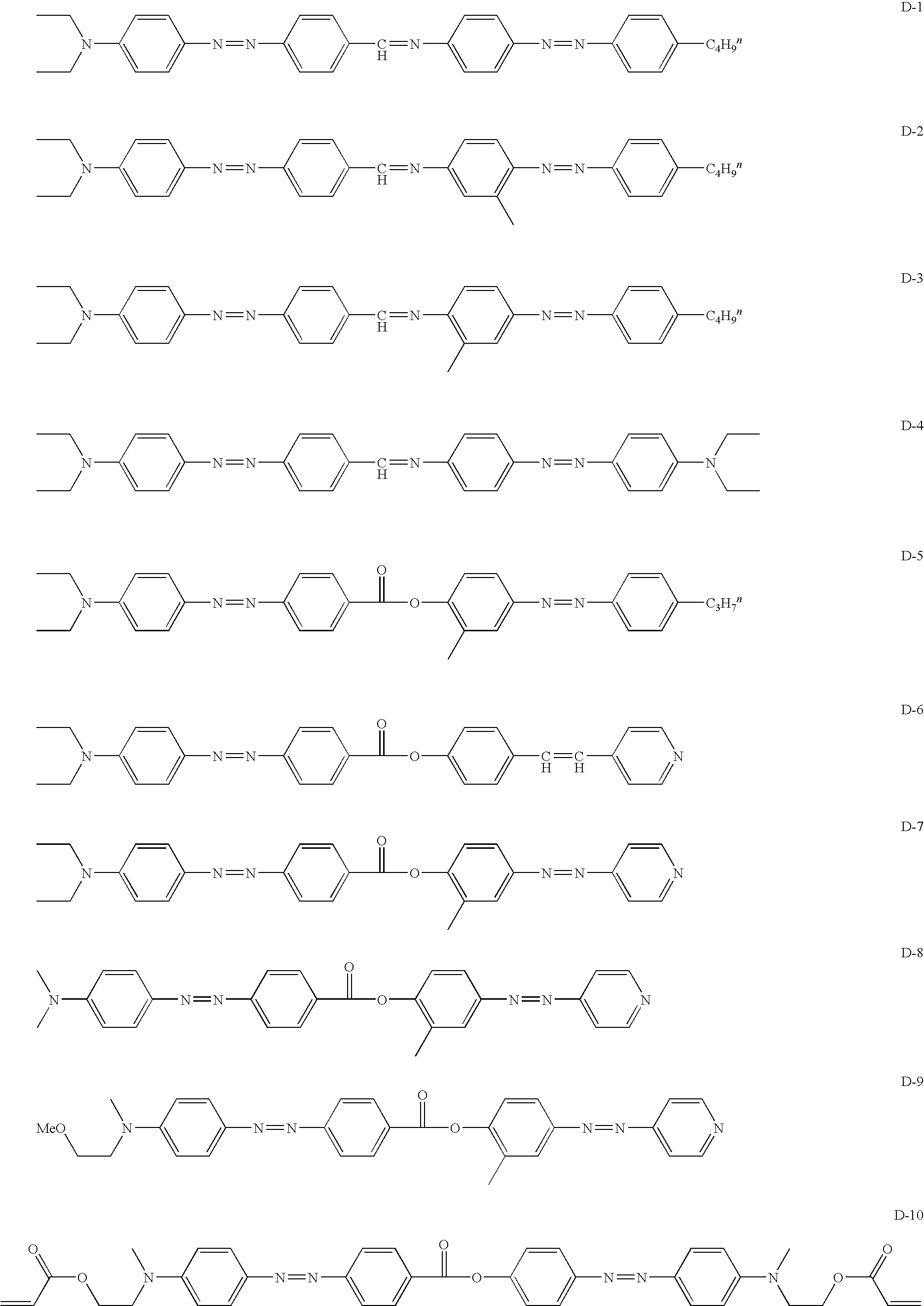

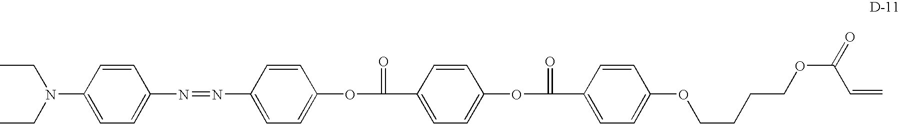

The compounds represented by any of formulae (I) to (VI) can be prepared in any methods, without particular limitation. For example, those compounds can be readily synthesized according to the methods described in Journal of Materials Chemistry (1999), 9(11), 2755-2763, and the like.

The liquid crystalline composition of the present invention contains at least two dichroic azo dyes. The content ratio of these dyes is determined in such a way that the nematic phase transition temperature of the composition containing these dyes is 120° C. or higher. The content of each dichroic azo dye in the liquid crystalline composition is preferably at least 5% by mass, more preferably 10% by mass or more, and most preferably 20% by mass or more. As for the content ratio between a plurality of dichroic azo dyes, providing that the liquid crystalline dichroic azo dye that is represented by formula (I) and has an expression temperature of the nematic phase of 150° C. to 300° C. in a temperature elevating process is 100 parts by mass, the other dichroic azo dye(s) is preferably from 10 to 900 parts by mass, and more preferably from 20 to 400 parts by mass.

Thus, by containing thereto two or more dichroic azo dyes, it is possible to obtain a dye composition having a high nematic phase transition temperature and suppressing crystallization at high temperature.

Meanwhile, the expression temperature of the nematic phase in a temperature elevating process can be measured by thermal analysis using a DSC measurement device (manufactured by Seiko Instrument Inc.), and by visual observation under a polarizing microscope.

In the present invention, the dichroic dye component may be used together with an azo dye other than the azo dye represented by the above-described formula (I), (II), (III), (IV) or (V), or alternatively together with a dye compound other than azo dyes. Examples of the dye compound include an azo series dye except the above-described compounds, a cyanine series dye, an azo metal complex, a phthalocyanine series dye, a pyrylium series dye, a thiopyrylium series dye, an azulenium series dye, a squarylium series dye, a naphthoquinone series dye, a triphenylmethane series dye and a triallyl methane series dye.

The content of the dichroic dye contained in the liquid crystalline composition of the present invention is preferably 70 mass % or more, particularly preferably 80 mass % or more, and the most preferably 90 mass % or more.

It is preferable that the liquid crystalline composition of the present invention contains at least one compound that is represented by the above-described formula (I) and has an expression temperature of the nematic phase of 150° C. to 300° C. in a temperature elevating process and at least one compound represented by the above-described formula (IV). The compound represented by formula (I) functions as an elevator (lift) of a nematic phase transition temperature of the liquid crystalline composition. In contrast, the compound represented by formula (IV) improves orientation of the liquid crystalline composition. As for the blend ratio of these compounds, the compound represented by formula (IV) is preferably contained in a proportion of 10 to 900 parts by mass, and more preferably from 20 to 400 parts by mass, relative to 100 parts by mass of the compound represented by formula (I).

### (Additives for Liquid Crystalline Composition)

Any organic solvent or additive may be used in the liquid crystalline composition of the present invention in combination with the above dichroic dye. Examples of the additive include an anti-unevenness-by-wind agent, an anti-cissing agent, an additive to control the tilt angle of an alignment film (tilt angle of the dichroic dye at the interface of the light absorption anisotropic film/the alignment film), an additive to control the tilt angle of air interface (tilt angle of the dichroic dye at the interface of the light absorption anisotropic film/air), a polymerization initiator, an additive (plasticizers) for decreasing an orientation temperature, saccharides, and a chemical agent or so having at least any function of an antifungal activity, an antibacterial activity and a sterilization activity. In the following, a description will be made about each additive.

### [Anti-Unevenness-by-Wind Agent]

Fluorine based polymers are suitably employable in general as a material for preventing unevenness by wind in a coating process of a coating solution containing the liquid crystalline compound of the present invention. The fluorine based polymers to be used are not particularly limited so long as not furiously obstruct a tilt angle change or orientation of the dichroic dye. JP-A-2004-198511, JP-A-2004-333852, JP-A-2005-179636 and JP-A-2005-206638 disclose about examples of the fluorine based polymer usable as the anti-unevenness-by-wind agent. Using fluorine based polymer together with the dichroic dye enables to display images of high display quality without generating the unevenness. Further, coating properties such as a cissing or so can be also improved. The addition amount of the fluorine based polymer used for the purpose of preventing the unevenness by wind without disturbing the orientation distribution of the dichroic dye is, in general, preferably within the range of 0.1 to 2 mass % with respect to the dichroic dye; more preferably within the range of 0.1 to 1 mass %, and furthermore preferably within the range of 0.4 to 1 mass %.

### [Anti-Cissing Agent]

Polymers are usually used as a material for preventing cissing while coating the liquid crystalline compound of the present invention. Any polymers, which can be mixed with the dichroic dye compatibly, can be used unless they change the tilt angle of the dichroic dye or inhibit alignment of the dichroic dye substantially. Examples of the polymer, which can be used as an anti-cissing agent, include the polymers disclosed in JP-A-8-95030, and especially preferred examples of the polymer include cellulose esters. Examples of the cellulose ester include cellulose acetate, cellulose acetate propionate, hydroxypropyl cellulose and cellulose acetate butyrate. Preventing the anti-cissing agent from inhibiting alignment of the dichroic dye, in usual, the amount of the polymer as the anti-cissing agent is preferably from 0.1 to 10 mass %, more preferably from 0.1 to 8 mass % and much more preferably from 0.1 to 5 mass % with respect to the total weight of the dichroic dye composition.

### [Agent for Controlling Tilt Angle of Alignment Film]

Any compound having both of a polar group and a non-polar group may be added to the liquid crystalline compound of the present invention for controlling a tilt angle of an alignment film. Examples of the compound having both of a polar group and a non-polar group include P^{O}—OH, P^{O}—COOH, P^{O}—O—P^{O}, P^{O}—NH₂, P^{O}—NH—P^{O}, P^{O}—SH, P^{O}—S—P^{O}, P^{O}—CO—P^{O}, P^{O}—COO—P^{O}, P^{O}—CONH—P^{O}, P^{O}—CONHCO—P^{O}, P^{O}—SO₃H, P^{O}—SO₃—P^{O}, P^{P}—SO₂NH—P^{O}, P^{O}—SO₂NHSO₂—P^{O}, P^{O}—C═N—P^{O}, HO—P(—OP^{O})₂, (HO—)₂PO—OP^{O}, P(—OP^{O})₃, HO—PO(—OP^{O})₂, (HO—)₂PO—OP^{O}, PO(—OP^{O})₃, P^{O}—NO₂ and P^{O}—CN; and organic salts thereof. Examples of the organic salts include organic salts of the above-described compound such as ammoniums, carboxylates, sulfonates; and pyridinium salts. Among these, P^{O}—OH, P^{O}—COOH, P^{O}—O—P^{O}, P^{O}—NH₂, P^{O}—SO₃H, HO—PO(—OP^{O})₂, (HO—)₂PO—OP^{O}, PO(—OP^{O})₃ and organic salts thereof are preferred. Herein, P^{O} represents a non-polar group. When there are plurality of P⁰, each P⁰ may be the same with, or different from each other.

Examples of P^{O} include an alkyl group (preferably a linear, branched or cyclic, substituted or unsubstituted alkyl group having 1 to 30 carbon atoms), an alkenyl group (preferably a linear, branched or cyclic, substituted or unsubstituted alkenyl group having 1 to 30 carbon atoms), an alkynyl group (preferably a linear, branched or cyclic, substituted or unsubstituted alkynyl group having 1 to 30 carbon atoms), an aryl group (preferably a substituted or unsubstituted aryl group having 6 to 30 carbon atoms) and a silyl group (preferably a substituted or unsubstituted silyl group having 3 to 30 carbon atoms). The non-polar group may have a substituent such as a halogen atom, an alkyl group (whose meaning includes a cycloalkyl group such as a monocyclo or bicyclo alkyl group), an alkenyl group (whose meaning include a cycloalkenyl group such as monocyclo or bicyclo alkenyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, aryloxycarbonyloxy group, an amino group (whose meaning includes an anilino group), an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imido group, a phosphino group, a phosphinyl group, a phosphinyloxy group, a phosphinylamino group and a silyl group.

In the present invention, adding an agent for controlling a tilt angle of an alignment film into the liquid crystalline composition coating solution or the like and orientating the dichroic dye in the presence of the agent for controlling a tilt angle of an alignment film enable to adjust the tilt angle of the dichroic dye at an alignment film interface. The addition amount of the agent for controlling a tilt angle of an alignment film is, in general, preferably from 0.0001 mass % to 30 mass % with respect to the mass of the dichroic dye, more preferably from 0.001 mass % to 20 mass %, and further more preferably from 0.005 mass % to 10 mass %. In the present invention, an agent for controlling a tilt angle of an alignment film disclosed in JP-A-2006-58801 are usable.

### [Polymerization Initiator]

It is preferable to form the light absorption anisotropic film by fixing oriented state of the dichroic dye, and it is also preferable to fix the dichroic dye by utilizing the polymerization reaction. Examples of polymerization reactions which can be used in the present invention include thermal polymerization reactions employing thermal polymerization initiators and photo-polymerization reactions employing photo-polymerization initiators. Photo-polymerization reactions are preferred to avoid a deformation or a degradation of a support of the anisotropic layer. It is possible to refer to descriptions from paragraph Nos. [0050] to [0051] in JP-A-2001-91741 with respect to various matters of the polymerization initiator such as examples of the polymerization initiator, a proper amount of the polymerization initiator to be used or proper photo-irradiation energy for polymerization.

### [Polymerizable Monomer]

Any polymerizable monomer may be used with the dichroic dye. Any polymerizable monomers, which can be mixed with the dichroic dye compatibly, can be used unless they contribute to varying a tile angle of the dichroic dye or inhibiting an alignment of the dichroic dye substantially. Among them, a compound having an ethylenically unsaturated group such as a vinyl group, a vinyloxy group, an acryloyl group or a methacryloyl group, may be preferably used. In usual, the amount of the polymerizable monomer is preferably from 1 to 50 mass %, and more preferably from 5 to 30 mass %, with respect to the total weight of the dichroic dye. When a polymerizable monomer having two or more reactive functional groups is used with the dichroic dye, the adhesion property between the light absorption anisotropic layer and the alignment film is improved.

### (Light Absorption Anisotropic Film)

In the present invention, after forming a wet-state light absorption anisotropic film by coating a coating liquid containing the above-described liquid crystalline composition as a component on the surface of alignment film, the formed light absorption anisotropic film is dried by evaporating an organic solvent, for example, according to a decompression treatment, whereby an eventual light absorption anisotropic film can be formed. By this method, a light absorption anisotropic film having a high dichroic ratio can be made.

One of intended uses of the light absorption anisotropic film is a polarizing element having both an alignment film and the light absorption anisotropic film. The polarizing element may be produced by a process including: (1) a step of subjecting a support or an alignment film formed on the support to rubbing treatment; (2) a step of applying a liquid crystalline composition dissolved in an organic solvent to the support or alignment film which has been rubbed; and (3) a step of vaporizing the above organic solvent to orientate the above liquid crystalline composition.

Each of the steps (1) to (3) will be explained in this order.

### (1) Rubbing Treatment Step

### (Step of Rubbing the Support or Alignment Film Formed on the Support)

In the above step of rubbing the support or alignment film formed on the support, the rubbing treatment means an operation for performing orientation treatment in which the surface of the support or the like is rubbed with a buff such as cotton cloth or absorbent cotton in a fixed direction to form microgrooves parallel to that direction and then a dichroic dye is applied to finally allow the dye to adsorb to the surface in an orientated state.

### [Support]

The support to be used for the present invention may be either a transparent support or an opaque support with an aide of coloring or so. The support is preferably transparent, and, in particular, preferably has a light transmission of 80% or more. The support is preferably selected from films formed of glass or optically isotropic polymers. Examples of such polymers or preferred embodiments of the support are same as those described in paragraph No. [0013] in JP-A-2002-22942. The films formed of the polymers, which are commonly known as easy to develop birefringence, such as polycarbonates or polysulfones, may be also used after being modified by the process described in WO00/26705 thereby to reduce the development of birefringence.

Polymer films of cellulose acetates having an acetylation rate from 55.0% to 62.5%, preferably from 57.0% to 62.0%, are preferably employed in the present invention. The preferred scope of acetylation rates and the preferred chemical structures of cellulose acetates are same as those described in paragraph No. [0021] in JP-A-2002-196146. It is disclosed in Journal of Technical Disclosure (Hatsumei Kyoukai Koukai Gihou) No. 2001-1745, published by Japan Institute of Invention and Innovation, cellulose acylate films produced by using chlorine-free solvents, and the cellulose acetate films described therein can be employed in the present invention.

The preferred scopes of the depth-retardation value and the birefringence value of the cellulose acetate film to be used as a transparent support are described in paragraph Nos. [0018] to [0019] in JP-A-2002-139621.

In order to control the retardation of a polymer film as the transparent support, especially a cellulose acetate film, aromatic compounds having at least two aromatic rings may be used as an agent for increasing retardation. The preferred scope and the preferred amount of the aromatic compound are same as those described in paragraph Nos. [0021] to [0023] in JP-A-2002-139621. Examples of such an agent for increasing retardation are described in WO01/88574, WO00/2619, JP-A-2000-111914, JPA-2000-275434, JP-A-2002-363343 or the like.

The cellulose acylate film, produced by a solvent-casting method using a cellulose acylate solution (dope), is preferably used. The dope may further comprise the agent for increasing retardation, and such a dope is preferred. Multilayered films can be produced by using the cellulose acylate solution (dope). The production of the films can be carried out according to the descriptions in paragraph Nos. [0038] to in JP-A-2002-139621.

Stretching treatment of the cellulose acetate film may be carried out in order to control its retardations. The stretch ratio is preferably from 3% to 100%. The cellulose acetate film is preferably stretched by tenters. For controlling the slow axis of the film to high accuracy, the deference in velocities, departure times and the like between of the left and right tenter clips are preferably as small as possible.

Plasticizes may be added to the cellulose ester films in order to improve the mechanical properties of the films and the drying speed. Examples of the plasticizer and the preferred scope of the plasticizers are same as those described in paragraph Nos. in JP-A-2002-139621.

Anti-degradation agents such as antioxidants, decomposers of peroxides, inhibitors of radicals, in-activators of metals, trapping agents of acids or amines, and UV ray protective agents, may be added to the cellulose ester film. The anti-degradation agents are described in paragraph No. [0044] in JP-A-2002-139621. The preferred example of the anti-degradation agent is butylated hydroxy toluene (BHT). The UV ray protective agents are described in JP-A-7-11056.

Surface treatment or measurement of solid-surface energy for the cellulose acylate film can be carried out according to the descriptions in paragraph Nos. [0051] to [0052] in JP-A-2002-196146.

The preferred thickness of the cellulose acylate film may vary depending on the application of the film, and, in usually, the thickness of the film is preferably from 5 to 500 more preferably from 20 to 250 μm and most preferably from 30 to 180 μm. Especially, for being used in optical applications, the thickness of the cellulose acylate film is preferably from 30 to 110 μm.

### [Alignment Film]

Any method can be used to form the alignment film on the above-described support as long as the dichroic dye in the light absorption anisotropic film on the alignment film can be oriented in a desired alignment. The alignment layer can be formed by rubbing treatment of an organic compound (preferably a polymer), by oblique evaporation of an inorganic compound, by formation of a micro groove layer, or by stimulation of an organic compound (e.g., w-tricosanoic acid, dioctadecylmethylammonium chloride, methyl stearate) according to a Langmuir-Blodgett (LB) method. Further, the aligning function of the alignment film can be activated by applying an electric or magnetic field to the film or by irradiating the film with light. In the present invention, the alignment film is preferably formed by rubbing a polymer layer. The rubbing treatment can be conducted by rubbing a polymer layer with paper or cloth several times in a certain direction, and is preferably conducted in the manner described in “Liquid Crystal Handbook (Ekisho Binran)” published on Oct. 30, 2000 by Maruzen CO., Ltd.

The thickness of the alignment film is preferably from 0.01 to 10 μm, and more preferably from 0.05 to 1 μm.

Various types of polymers which can be used for producing alignment films are described in various documents, and various polymers are commercially available. According to the present invention, alignment layers formed of polyvinyl alcohols or derivatives thereof are preferably used. Especially, alignment films formed of modified polyvinyl alcohols bonding with hydrophobic groups are preferable. Regarding various matters of the alignment film, it is possible to refer to the descriptions from line 24 of p. 43 to line 8 of p. 49 in WO01/88574A1.

### [Rubbing-Density of Alignment Film]

It is possible to vary a rubbing-density of an alignment film by a method described in “Handbook of liquid Crystal (Ekisyo Binran)” published by MARUZEN CO., Ltd. on Oct. 30, 2000. A rubbing-density (L) is quantified by a formula (A) below.

L=N1{1+(2πrn/60v)} Formula (A)

In formula (A), N is a number of rubbing, 1 is a contact length of a rubbing-roller, r is a roller-radius, n is revolutions per minute (rpm) and v is moving velocity (per second).

The rubbing-density may be increased by increasing the number of rubbing, lengthening the contact length of the rubbing roller, increasing radius of the roller, increasing revolutions per minute of the roller and/or decreasing moving velocity. On the other hand, the rubbing-density may be decreased by doing the reverse thereof.

There is a relationship between a rubbing-density and a pre-tilt angle of the alignment film that the pre-tilt angle is decreased as the rubbing-density is higher, and the pre-tilt angle is increased as the rubbing-density is lower.

### (2) Coating Step

### (A Step of Applying a Coating Solution Prepared by Dissolving a Liquid Crystalline Composition in an Organic Solvent, to the Rubbed Support or Alignment Film)

This is a step of applying a coating solution obtained by dissolving a liquid crystalline composition in an organic solvent to the above rubbed support or alignment film.

### [Solvent for Preparing a Coating Liquid]

It is preferable for the light absorption anisotropic film of the present invention to be formed by using the coating liquid containing the liquid crystalline composition of the present invention. The solvent which is used for preparing the coating liquid is preferably selected from organic solvents. Examples of the organic solvent include amides such as N,N-dimethylformamide, sulfoxides such as dimethylsulfoxide, heterocyclic compounds such as pyridine, hydrocarbons such as benzene or hexane, alkyl halides such as chloroform or dichloromethane, esters such as methyl acetate or butyl acetate, ketones such as acetone or methylethyl ketone and ethers such as tetrahydrofuran or 1,2-dimethoxyethane. Among these, alkyl halides or ketones are preferred. Plural types of organic solvents may be used in combination.

### [Coating Manner]

The liquid crystalline composition coating liquid may be applied by ordinary techniques (e.g., wire bar coating, extrusion coating, direct gravure coating, reverse gravure coating, die coating and inkjet method). The liquid crystalline composition coating liquid preferably contains the dichroic dye in an amount from 1 to 20 mass % more preferably from 1 to 10 mass %, and further preferably from 1 to 5 mass %.

It is preferable for the light absorption anisotropic film of the present invention to be formed in accordance with a wet film-forming method. For the purpose of producing the light absorption anisotropic film in the present invention, after preparing the coating liquid containing the liquid crystalline composition of the present invention, publicly known methods of applying the composition onto various substrates such as glass plate, so that the dye is orientated and laminated are adopted.

As the wet film-forming method, for example, a known method as disclosed in e.g. “Coating Engineering”, Yuji Harasaki (Asakura Shoten K. K., published on Mar. 20, 1971) pages 253-277 or “Creation and Applications of Harmonized Molecular Materials” supervised by Kunihiro Ichimura (CMC Publishing Co., Ltd., published on March. 3, 1998) pages 118-149, or a method of coating on a substrate preliminarily subjected to an alignment treatment by means of e.g. spin coating, spray coating, bar coating, roll coating, blade coating, free span coating, dye coating, or inkjet method may be mentioned.

The temperature at the time of coating is preferably from 0° C. to 80° C. Further, the humidity is preferably from 10% RH to 80% RH.

Further, when the dye film is applied by the wet process film forming method, a substrate such as the support may be warmed or may be cooled too. Further, the temperature of the support in this occasion is preferably from 10° C. to 60° C. When the temperature is too high, there is a fear that the orientation distribution is disturbed before being dried under reduced pressure described below. When the temperature is too low, there is a fear that water drop attaches onto the support and obstructs the coating. When the dye film coated in accordance with the wet system film-forming method is dried under the reduced pressure, the support may be warmed. The temperature of the support in this occasion is preferably 60° C. or less. When the temperature is too high, there is a fear that the orientation distribution is disturbed before being dried under reduced pressure.

Further, in a case where the light absorption anisotropic film of the present invention is used as e.g. a polarizing filter for various display devices such as LCD or OLED, the anisotropic film may be formed directly on e.g. an electrode substrate constituting such a display device, or a substrate having the dye film formed thereon may be used as a constituting component of such a display device.

In the present invention, the light absorption anisotropic film is formed by applying the dichroic liquid crystalline composition of the present invention on a support orientated unilaterally in the direction having an angle not parallel with respect to the orientation treatment direction. Further, it is more preferable that the liquid crystalline composition of the present invention is applied in the direction almost the same as longitudinal or lateral direction of the support. By the above process, a light absorption anisotropic film without any optical defect and having high dichroic ratio can be provided. In addition, after applying the liquid crystalline composition, cutting out the support for the purpose of providing a necessary polarization angle is not required, and accordingly, the productivity is high.

JP-A-2007-127987, for example, discloses about preferred coating manners for the liquid crystalline composition of the present invention.

### (3) Drying and Orientation Step

(A Step of Vaporizing the Above Organic Solvent to thereby Orientate the Above Liquid Crystalline Composition)

This is a step which is carried out in succession to the coating step for vaporizing the organic solvent from the coating film of the organic solvent solution to orientate the liquid crystalline composition. As regards the drying temperature, in this case, the coating film is preferably air-dried at room temperature so as not to disorder (to avoid, for example, heat relaxation) the state of orientation of the dye formed by application. It is more preferable to carry out pressure reducing treatment to vaporize the solvent, thereby drying at lower temperatures.

In this occasion, pressure reducing treatment means that the coating film (light absorption anisotropic film) is left under the condition of reduced pressure, and the solvent is removed by vaporizing. At this moment, it is preferable that the support having the light absorption anisotropic film is maintained to be horizontal without moving from the higher position toward the lower position.

Regarding with the time interval before starting the pressure reduction treatment of the light absorption anisotropic film after coating, the shorter, the better, and it is preferable to be from 1 second to 30 seconds.

Examples of the method for pressure reducing treatment include the following methods. Namely, the light absorption anisotropic film prepared by applying the coating liquid onto the support is introduced into a pressure reducing apparatus and receive the pressure reduction treatment. For example, the pressure reduction apparatus illustrated in FIG. 9 or FIG. 10 of JP-A-2006-201759 can be used. JP-A-2004-169975 discloses about the pressure reducing apparatus in detail.

With regard to the condition of pressure reducing treatment, the pressure among the system in which the dye film exists is preferably 2×10⁴ Pa or less, further preferably 1×10⁴ Pa or less and particularly preferably 1×10³ Pa or less. In addition, it is preferably 1 Pa or more, and further preferably 1×10¹ Pa or more. Usually, it is preferable for the pressure to which the system reaches finally to be as the above description. When the pressure is too high, there is a fear that the drying becomes impossible and orientation distribution is disturbed. When the pressure is too low, the drying becomes so rapid that there is a fear of generating defects.

Further, the time for pressure reduction treatment is preferably from 5 seconds to 180 seconds. When the time is too long, there is a fear that the rapid drying of the dye film before relaxation of the orientation becomes impossible and the orientation distribution is disturbed. When the time is too short, there is a fear that the drying becomes impossible and the orientation distribution is disturbed.

Further, with regard to the temperature among the system in the occasion of the pressure reducing treatment, it is preferably from 10° C. to 60° C. When the temperature is too high, there is a fear that convection occurs during the drying and non-uniformity generates in the coated film. When the temperature is too low, there is a fear that the drying becomes impossible and the orientation distribution is disturbed.

The light absorption anisotropic film after the drying has a thickness of preferably 0.01 to 2 μm, more preferably of 0.05 to 2 μm, and further preferably of 0.1 to 2 μm.

A dye film containing an oriented dichroic dye thus obtained is an anisotropic dye film having an anisotropic nature of light absorption, and may form an element having a function as a polarization film (polarizing element).

In this case, the formed anisotropic dye film itself may be used as a polarizing element. Alternatively, a protective layer, an adhesive layer and an antireflection layer may be additionally formed on the anisotropic dye film

Further, formation of a liquid crystal element by using the anisotropic dye film is favorably achieved by a method in which, in the course of the above-described steps (1), (2) and (3), a transparent electrode such as ITO is formed on a support (substrate) beforehand, and then the anisotropic dye film (polarization film) is formed on the transparent electrode. In this case, polyimide, polyvinyl alcohol or the like may be coated on the transparent electrode that contacts the dye film, and then parallel orientation is secured by a rubbing process, and then steps such as the above-described coating or the like are performed.

### (Properties of Light Absorption Anisotropic Film)

When the coating liquid containing the liquid crystalline composition of the present invention is applied to a surface of the alignment film, the dichroic dye may be aligned with a tilt angle of an alignment film at an alignment layer interface and with a tilt angle of air interface at an air interface. After applying the coating liquid containing the liquid crystalline composition of the present invention to the surface of the alignment film, the dichroic dye is aligned uniformly (to make monodomain alignment), to achieve horizon alignment state.

The light absorption anisotropic film formed by horizontally orientating the dichroic dye and by fixing the oriented state can be used as a polarizing element.

### [Tilt Angle]

In the present invention, the term of “tilt angle” means an angle formed between a long axis of a dichroic dye molecule and an interface (alignment film interface or an air interface). Narrowing the tilt angle at the alignment film side to an extent and horizontally orientating provide preferable optical performance as the polarizing element efficiently. Accordingly, from the viewpoints of polarization performance, the tilt angle at the alignment film side is preferably from 0° to 10°, further preferably from 0° to 5°, particularly preferably from 0° to 2°, and the most preferably from 0° to 1°. In addition, preferable tilt angle at the air interface side is from 0° to 10°, further preferably from 0 to 5°, particularly preferably from 0 to 2°.

Generally, a tilt angle of the dichroic dye at the air interface side can be adjusted by using the above-described horizontally orienting agent or another compound (for example, horizontally orientating agents disclosed in JP-A-2005-99248, JP-A-2005-134884, JP-A-2006-126768 and JP-A-2006-267183) to be added optionally, and the preferable horizontal orientated state can be realized as a polarizing element of the liquid crystal display device to which the light absorption anisotropic film of the present invention is applied.

In addition, the tilt angle of the dichroic dye at the alignment film side can be controlled by the above mentioned manner (for example, by using the agent for controlling a tilt angle at an alignment film, and the like).

### (Usage of Light Absorption Anisotropic Film)

The light absorption anisotropic film of the present invention formed by the above-described manner will function as a polarizing film whereby a linearly polarized light, circularly polarized light or oval polarized light can be obtained by utilizing the anisotropy in light absorption and further is capable of providing functions as various anisotropic films such as refractive anisotropy and conductivity anisotropy by selecting the film-forming process, the support and the composition containing the dye, whereby it can be made various types of polarizing elements which can be used for various purposes.

In a case where the light absorption anisotropic film of the present invention is formed on a support to use as a polarizing element, the formed light absorption anisotropic film itself may be used, or not only the above-mentioned protective layer but also layers having various functions such as an adhesive layer and a reflection-preventing layer, an alignment film, and layers having optical functions such as a function as a phase difference film, a function as a brightness-improved film, a function as a reflective film, a function as a semi-transmissive reflective film and a function as a diffusion film may be formed by lamination by e.g. a wet film-forming method, so that it may be used in the form of a laminate.

Such layers having optical functions may be formed, for example, by the following methods.

A layer having a function as a phase difference film may be formed by applying a stretching treatment as disclosed in e.g. Japanese Patent No. 2841377 or Japanese Patent No. 3094113, or by applying a treatment as disclosed in e.g. Japanese Patent No. 3168850.

Further, a layer having a function as a brightness-improved film may be formed by forming ultrafine pores by a method as disclosed in e.g. JP-A-2002-169025 or JP-A-2003-29030, or by superposing two or more cholesteric liquid crystal layers with different central wavelengths of the selective reflection.

A layer having a function as a reflective film or a semi-transmissive reflective film may be formed by using a metal thin film obtained by deposition or sputtering.

A layer having a function as a diffusion film may be formed by coating the above protective layer with a resin solution containing fine particles.

Further, a layer having a function as a phase difference film or an optical compensation film may be formed by applying a liquid crystalline compound such as a discotic liquid crystalline compound and orienting it.

The liquid crystal display device of the present invention is not particularly restricted, so far as the display device has a light absorption anisotropic film, a polarizing element and the like, which are produced by using the above-described liquid crystalline composition, and also its liquid crystallinity has been utilized in the display device. Specifically, examples of application of the display device include a projector and a car navigation.

The present invention can provide a dye composition having both the liquid crystallinity and high dichroism. Also, the present invention can provide a light absorption anisotropic film, a polarizing element and a liquid crystal display device all employing the dye composition.

The present invention will be described in more detail based on the following examples, but the present invention is not limited thereto.

In the following examples, the measurements regarding with the optical performance and the phase transition temperature of the light absorption anisotropic film were executed as described below.

### EXAMPLES

### Dichroic Ratio

A dichroic ratio was calculated using the following equation after measuring an absorbance of the light absorption anisotropic film with a spectral photometer arranging an iodine series polarizing element in an incident light optical system.

Dichroic Ratio(D)=Az/Ay

Az: Absorbance of a light absorption anisotropic film for a polarized light in the absorption axis direction
Ay: Absorbance of a light absorption anisotropic film for a polarized light in the polarization axis direction

### <Phase Transition Temperature>

The expression temperature of the nematic phase in a temperature elevating process was measured by a method in which a temperature of a liquid crystalline composition is gradually elevated from a crystal phase temperature (about −50° C.), and a temperature at which the liquid crystalline composition transits from the crystal phase to the nematic phase is measured by thermal analysis. For the thermal analysis, a DSC measuring instrument manufactured by Seiko Instruments Inc was used. To determine whether the phase transition is from the crystal phase to the nematic phase or not, a volume of endothermic quantity arising from the phase transition was measured and a visual observation was carried out using a polarizing microscope. The expression temperature of from the nematic phase to the isotropic phase in a temperature elevating process was also measured in the same manner as the above method.

### Example 1

To 98 mass parts of chloroform, 1.6 mass parts of a dichroic azo dye No. (A-5) (nematic phase transition temperature: 235° C.) and 0.4 mass parts of a dichroic azo dye No. (B-16) (nematic phase transition temperature: 137° C.) were added, and the mixture was stirred and dissolved, to obtain a liquid crystalline composition coating solution. Next, the above coating solution was applied to the following polyvinyl alcohol alignment film which was formed on a glass substrate and rubbed, and then, the film was air-dried at room temperature to remove chloroform.

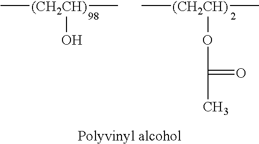

The dichroic ratio (D) calculated from absorbance of the dye film for a polarized light having a vibration plane in the absorption axis direction (Az) and absorbance of the dye film for a polarized light having a vibration plane in the polarization axis direction (Ay) and phase transition temperatures of the resultant light absorption anisotropic film are shown in Table 1. As for determination of phase transition temperature, the above-described coating liquid was coated on a glass substrate and then removed chloroform naturally at room temperature. Then, using the resultant dried coating, appearance of phase transition thereof was observed with an optical microscope to determine a phase transition temperature. Thereafter, the light absorption anisotropic film was heated at 140° C., and left for 2 hours, and then a dichroic ratio was measured again. The results are shown in Table 1.

### Example 2

A light absorption anisotropic film was produced in the same manner as in Example 1, except that quantities of A-5 and B-16 were changed to 1.2 parts by mass and 0.8 parts by mass, respectively.

The dichroic ratio (D) calculated from absorbance of the dye film for a polarized light having a vibration plane in the absorption axis direction (Az) and absorbance of the dye film for a polarized light having a vibration plane in the polarization axis direction (Ay), phase transition temperatures and dichroic ratio measured after the light absorption anisotropic film was heated at 140° C., and left for 2 hours of the resultant light absorption anisotropic film are shown in Table 1.

### Example 3

A light absorption anisotropic film was produced in the same manner as in Example 1, except that quantities of A-5 and B-16 were changed to 0.8 parts by mass and 1.2 parts by mass, respectively.

The dichroic ratio (D) calculated from absorbance of the dye film for a polarized light having a vibration plane in the absorption axis direction (Az) and absorbance of the dye film for a polarized light having a vibration plane in the polarization axis direction (Ay), phase transition temperatures and dichroic ratio measured after the light absorption anisotropic film was heated at 140° C., and left for 2 hours of the resultant light absorption anisotropic film are shown in Table 1.

### Example 4

A light absorption anisotropic film was produced in the same manner as in Example 1, except that quantities of A-5 and B-16 were changed to 0.4 parts by mass and 1.6 parts by mass, respectively.

The dichroic ratio (D) calculated from absorbance of the dye film for a polarized light having a vibration plane in the absorption axis direction (Az) and absorbance of the dye film for a polarized light having a vibration plane in the polarization axis direction (Ay), phase transition temperatures and dichroic ratio measured after the light absorption anisotropic film was heated at 140° C., and left for 2 hours of the resultant light absorption anisotropic film are shown in Table 1.

### Example 5

A light absorption anisotropic film was produced in the same manner as in Example 1, except that 0.8 parts by mass of azo dye A-5 and 0.2 parts by mass of azo dye D-5 (nematic phase transition temperature: 187° C.) were replaced as A-5 and B-16, respectively.

The dichroic ratio (D) calculated from absorbance of the dye film for a polarized light having a vibration plane in the absorption axis direction (Az) and absorbance of the dye film for a polarized light having a vibration plane in the polarization axis direction (Ay), phase transition temperatures and dichroic ratio measured after the light absorption anisotropic film was heated at 140° C., and left for 2 hours of the resultant light absorption anisotropic film are shown in Table 1.

### Reference Example 1

A light absorption anisotropic film was produced in the same manner as in Example 1, except that 2.0 parts by mass of A-5 was only used as an azo dye.

The dichroic ratio (D) calculated from absorbance of the dye film for a polarized light having a vibration plane in the absorption axis direction (Az) and absorbance of the dye film for a polarized light having a vibration plane in the polarization axis direction (Ay), phase transition temperatures and dichroic ratio measured after the light absorption anisotropic film was heated at 140° C., and left for 2 hours of the resultant light absorption anisotropic film are shown in Table 1.

### Reference Example 2

A light absorption anisotropic film was produced in the same manner as in Example 1, except that 2.0 parts by mass of B-16 was only used as an azo dye.

The dichroic ratio (D) calculated from absorbance of the dye film for a polarized light having a vibration plane in the absorption axis direction (Az) and absorbance of the dye film for a polarized light having a vibration plane in the polarization axis direction (Ay), and phase transition temperatures of the resultant light absorption anisotropic film are shown in Table 1.

Then, the light absorption anisotropic film was heated at 140° C., and as a result it was confirmed that due to crystallization of the dye and conspicuous disturbance of orientation distribution occurred.

### Reference Example 3

A light absorption anisotropic film was produced in the same manner as in Example 1, except that 2.0 parts by mass of C-9 was only used as an azo dye.

The dichroic ratio (D) calculated from absorbance of the dye film for a polarized light having a vibration plane in the absorption axis direction (Az) and absorbance of the dye film for a polarized light having a vibration plane in the polarization axis direction (Ay), and phase transition temperatures of the resultant light absorption anisotropic film are shown in Table 1.

Then, the light absorption anisotropic film was heated at 140° C., and as a result it was confirmed that due to crystallization of the dye and conspicuous disturbance of orientation distribution occurred.

### Reference Example 4

A light absorption anisotropic film was produced in the same manner as in Example 1, except that 2.0 parts by mass of D-5 was only used as an azo dye.

The dichroic ratio (D) calculated from absorbance of the dye film for a polarized light having a vibration plane in the absorption axis direction (Az) and absorbance of the dye film for a polarized light having a vibration plane in the polarization axis direction (Ay), and phase transition temperatures of the resultant light absorption anisotropic film are shown in Table 1.

Then, the light absorption anisotropic film was heated at 140° C., and as a result it was confirmed that due to crystallization of the dye and conspicuous disturbance of orientation distribution occurred.

### Reference Example 5

A light absorption anisotropic film was produced in the same manner as in Example 1, except that 2.0 parts by mass of B-46 was only used as an azo dye.

The dichroic ratio (D) calculated from absorbance of the dye film for a polarized light having a vibration plane in the absorption axis direction (Az) and absorbance of the dye film for a polarized light having a vibration plane in the polarization axis direction (Ay), and phase transition temperatures of the resultant light absorption anisotropic film are shown in Table 1.

Then, the light absorption anisotropic film was heated at 140° C., and as a result it was confirmed that due to crystallization of the dye and conspicuous disturbance of orientation distribution occurred.

### Reference Example 6

A light absorption anisotropic film was produced in the same manner as in Example 1, except that 0.4 parts by mass of azo dye B-16 and 1.6 parts by mass of azo dye B-46 were replaced as A-5 and B-16, respectively.

The dichroic ratio (D) calculated from absorbance of the dye film for a polarized light having a vibration plane in the absorption axis direction (Az) and absorbance of the dye film for a polarized light having a vibration plane in the polarization axis direction (Ay), and phase transition temperatures of the resultant light absorption anisotropic film are shown in Table 1.

Then, the light absorption anisotropic film was heated at 140° C., and as a result it was confirmed that due to crystallization of the dye and conspicuous disturbance of orientation distribution occurred.

TABLE 1

| | Azo dye No. | Dichroic ratio (D) | Dichroic ratio (D) | Phase transition temperature |
|---|---|---|---|---|
| | (content, mass %) | (just after coating) | (140° C., after 2 hours) | of composition (° C.) |
| Example 1 | A-5(80)/B-16(20) | 23.0 | 23.0 | K 224° C. N 248° C. I |
| Example 2 | A-5(60)/B-16(40) | 28.0 | 40.9 | K 209° C. N 246° C. I |
| Example 3 | A-5(40)/B-16(60) | 73.0 | 40.9 | K 160° C. N 258° C. I |
| Example 4 | A-5(20)/B-16(80) | 73.0 | 28.0 | K 128° C. N 258° C. I |
| Example 5 | A-5(80)/D-5(20) | 90.0 | 82.3 | K 230° C. N 243° C. I |
| Reference Example 1 | A-5(100) | 41.0 | 1.9 | K 235° C. N 240° C. I |
| Reference Example 2 | B-16(100) | 58.0 | Crystallization | K 137° C. N 266° C. I |
| Reference Example 3 | C-9(100) | 58.0 | Crystallization | K 168° C. N 288° C. I |
| Reference Example 4 | D-5(100) | 10.5 | Crystallization | K 187° C. N 248° C. I |
| Reference Example 5 | B-46(100) | 16.0 | Crystallization | K 158° C. N 240° C. I |
| Reference Example 6 | B-16(20)/B-46(80) | 28.0 | Crystallization | K 55° C. N 246° C. I |

K: Crystalline Phase
N: Nematic Phase
I: Isotropic Phase

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2009-7463 filed in Japan on Jan. 16, 2009, which is entirely herein incorporated by reference.

What we claim is:

1. A liquid crystalline composition, comprising a liquid crystalline dichroic azo dye that is represented by formula (I) and has an expression temperature of the nematic phase of 150° C. to 300° C. in a temperature elevating process, and at least one liquid crystalline dichroic azo dye, wherein an expression temperature of the nematic phase of the liquid crystalline composition is 120° C. or higher in a temperature elevating process: 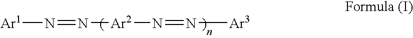
wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.

2. The liquid crystalline composition according to claim 1, wherein the dichroic azo dye represented by formula (I) is a compound represented by formula (II): 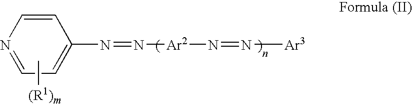
wherein R¹ represents a substituent; Ar² is a divalent substituted or unsubstituted aromatic hydrocarbon group or a divalent substituted or unsubstituted aromatic heterocyclic group; Ar³ represents a substituted or unsubstituted, aromatic hydrocarbon ring group or aromatic heterocyclic group; n represents an integer of 1 or more; when n is an integer of 2 or more, Ar²s may be the same as or different from each other; m represents an integer of 0 to 4; and when m is an integer of 2 or more, R¹s may be the same as or different from each other.

3. The liquid crystalline composition according to claim 2, wherein the dichroic azo dye represented by formula (II) is a compound represented by formula (III): 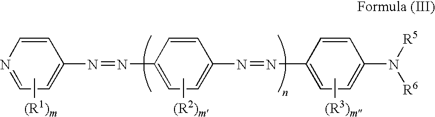
wherein R¹, R², R³, R⁵ and R⁶ each independently represent a substituent; n represents an integer of 1 or more; when n is an integer of 2 or more, R²s may be the same as or different from each other; m represents an integer of 0 to 4; when m is an integer of 2 or more, R¹s may be the same as or different from each other; m′ represents an integer of 0 to 4; when m′ is an integer of 2 or more, R²s may be the same as or different from each other; m″ represents an integer of 0 to 4; when m″ is an integer of 2 or more, R³s may be the same as or different from each other; when two or more than two R² or R³ are present, a plurality of R² or R³ may bond to each other to form a ring respectively; and R³, R⁵, and R⁶ may bond to each other to form a ring.

4. The liquid crystalline composition according to claim 3, comprising a liquid crystalline dichroic azo dye that is represented by the above-described formula (III) and has an expression temperature of the nematic phase of 150° C. to 300° C. in a temperature elevating process, and at least one liquid crystalline dichroic azo dye represented by formula (IV): 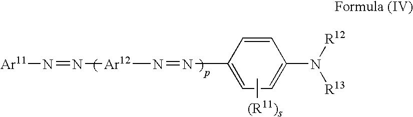
wherein R¹¹, R¹² and R¹³ each independently represent a hydrogen atom or a substituent; Ar¹¹ is a substituted or unsubstituted phenyl group, a substituted or unsubstituted naphthyl group, or a substituted or unsubstituted aromatic heterocyclic group excluding a pyridyl group; Ar¹² is a divalent substituted or unsubstituted aromatic hydrocarbon group or a divalent substituted or unsubstituted aromatic heterocyclic group; s represents an integer of 0 to 4; when s is an integer of 2 or more, R¹¹s may be the same as or different from each other; p represents an integer of 1 to 5; and when p is an integer of 2 or more, Ar¹²s may be the same as or different from each other.

5. The liquid crystalline composition according to claim 4, wherein, in formula (IV), Ar¹¹ represents a substituted or unsubstituted phenyl group; Ar¹² represents a divalent substituted or unsubstituted phenylene group; and p represents an integer of 2 to 4.

6. The liquid crystalline composition according to claim 4, wherein the azo dye represented by formula (IV) is a compound represented by formula (V): 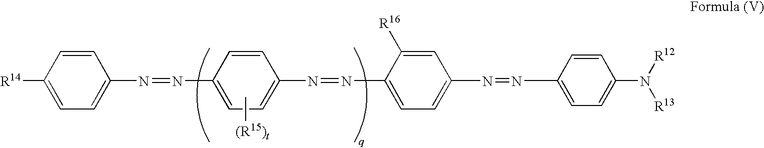
wherein R¹², R¹³ and R¹⁵ each independently represent a hydrogen atom or a substituent; R¹⁴ represents a substituted or unsubstituted, alkyl group, alkenyl group, alkynyl group, aryl group, alkoxy group, alkoxycarbonyl group, acyloxy group, acylamino group, alkoxycarbonylamino group, sulfonylamino group, sulfamoyl group, carbamoyl group, alkylthio group, sulfonyl group or ureido group; R¹⁶ represents an alkyl group; t represents an integer of 0 to 4; when t is an integer of 2 or more, R¹⁵s may be the same as or different from each other; and q represents an integer of 1 to 3.

7. The liquid crystalline composition according to claim 1, comprising a liquid crystalline dichroic azo dye that is represented by the above-described formula (I) and has an expression temperature of the nematic phase of 150° C. to 300° C. in a temperature elevating process, and at least one liquid crystalline dichroic azo dye represented by formula (IV): 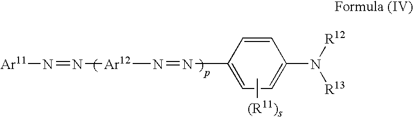
wherein R¹¹, R¹² and R¹³ each independently represent a hydrogen atom or a substituent; Ar¹¹ is a substituted or unsubstituted phenyl group, a substituted or unsubstituted naphthyl group, or a substituted or unsubstituted aromatic heterocyclic group excluding a pyridyl group; Ar¹² is a divalent substituted or unsubstituted aromatic hydrocarbon group or a divalent substituted or unsubstituted aromatic heterocyclic group; s represents an integer of 0 to 4; when s is an integer of 2 or more, R¹¹s may be the same as or different from each other; p represents an integer of 1 to 5; and when p is an integer of 2 or more, Ar¹²s may be the same as or different from each other.

8. The liquid crystalline composition according to claim 7, wherein, in formula (IV), Ar¹¹ represents a substituted or unsubstituted phenyl group; Ar¹² represents a divalent substituted or unsubstituted phenylene group; and p represents an integer of 2 to 4.

9. The liquid crystalline composition according to claim 7, wherein the azo dye represented by formula (IV) is a compound represented by formula (V): 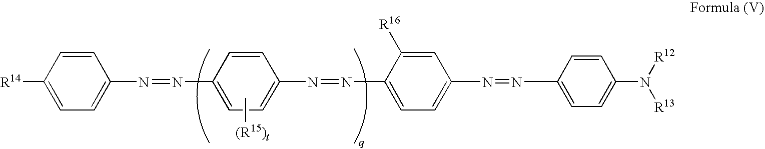
wherein R¹², R¹³ and R¹⁵ each independently represent a hydrogen atom or a substituent; R¹⁴ represents a substituted or unsubstituted, alkyl group, alkenyl group, alkynyl group, aryl group, alkoxy group, alkoxycarbonyl group, acyloxy group, acylamino group, alkoxycarbonylamino group, sulfonylamino group, sulfamoyl group, carbamoyl group, alkylthio group, sulfonyl group or ureido group; R¹⁶ represents an alkyl group; t represents an integer of 0 to 4; when t is an integer of 2 or more, R¹⁵s may be the same as or different from each other; and q represents an integer of 1 to 3.

10. A light absorption anisotropic film formed by employing the liquid crystalline composition according to claim 1.

11. A polarizing element comprising an alignment film and the light absorption anisotropic film according to claim 10 on a support.

12. A liquid crystal display device comprising the light absorption anisotropic film according to claim 10.

13. A liquid crystal display device comprising the polarizing element according to claim 11.

14. A method of producing the polarizing element according to claim 11, comprising the steps of:
(1) rubbing a support or an alignment film formed on a support;
(2) applying the liquid crystalline composition according to claim 1 dissolved in an organic solvent on the rubbing treated support or alignment film; and
(3) orientating the liquid crystalline composition by causing the organic solvent to evaporate.

15. A method of producing the liquid crystalline composition according to claim 1, the method comprising a step of mixing a liquid crystalline dichroic azo dye that is represented by formula (I) and has an expression temperature of the nematic phase of 150° C. to 300° C. in a temperature elevating process, and at least one liquid crystalline dichroic azo dye, thereby obtaining a liquid crystalline composition having an expression temperature of the nematic phase of 120° C. or more in a temperature elevating process. 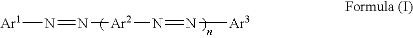
wherein Ar¹ and Ar³ each independently represent a substituted or unsubstituted, aromatic hydrocarbon ring group or aromatic heterocyclic group; Ar² is a divalent substituted or unsubstituted aromatic hydrocarbon group or a divalent substituted or unsubstituted aromatic heterocyclic group; n represents an integer of 1 or more; and when n is an integer of 2 or more, Ar²s may be the same as or different from each other.
